(19) United States
(12) Patent Application Publication
(10) Pub. No.: US 2019/0128291 A1
(43) Pub. Date: May 2, 2019

(54) PRESSURE RESISTANT APPARATUS AND FLUID PRESSURE CYLINDER

(71) Applicant: KYB Corporation, Tokyo (JP)

(72) Inventors: Toshio KOBAYASHI, Gifu (JP); Kazuhiko MATSUMOTO, Gifu (JP); Norifumi IMAI, Gifu (JP); Takahiro HIKASA, Gifu (JP)

(73) Assignee: KYB Corporation, Tokyo (JP)

(21) Appl. No.: 16/093,710

(22) PCT Filed: Apr. 13, 2017
(86) PCT No.: PCT/JP2017/015194

§ 371 Date: Oct. 15, 2018

(30) Foreign Application Priority Data
Apr. 18, 2016 (JP) 2016-083129
Apr. 18, 2016 (JP) 2016-083130

(51) Int. Cl. F15B 15/28; F15B 15/14

(52) U.S. Cl. CPC F15B 15/2846; F15B 15/1457; F15B 15/1428

(57) ABSTRACT

A pressure resistant apparatus includes a cylindrical body portion, and a lid portion having an annular wall portion, end portions of the body portion and the wall portion being joined to each other to close an opening of the body portion by the lid portion, wherein an annular first groove portion is formed to extend in a peripheral direction on at least one of inner peripheral surfaces of the body portion and the wall portion, and an inner diameter of the first groove portion is larger than inner diameters of the body portion and the end portion of the wall portion.

### TECHNICAL FIELD

The present invention relates to a pressure resistant apparatus and a fluid pressure cylinder.

### BACKGROUND ART

JP2-53643B2 and JP60-196003U disclose a hydraulic cylinder which is a kind of a pressure resistant apparatus. In the hydraulic cylinder disclosed in JP2-53643B2, an annular wall portion is formed on a cylinder bottom, and the annular wall portion on the cylinder bottom and a cylinder tube are joined by welding. In the hydraulic cylinder disclosed in JP60-196003U, a peripheral wall protruding annularly is formed on a rear lid fixed to the cylinder tube, and end surfaces of the cylinder tube and the peripheral wall on the rear lid are joined by welding.

### SUMMARY OF INVENTION

In the cylinder (pressure resistant apparatus) disclosed in JP2-53643B2, a projection can be formed on an inner peripheral surface of the cylinder in some cases by a joint portion formed by welding between the cylinder tube and the annular wall portion. If an axial force acts on the cylinder in a state where the projection is formed, a stress is concentrated in a root of the projection, and there is a concern that the cylinder is broken. A cylinder having sufficient durability even in a state where the projection is formed is in demand.

The present invention has an object to improve durability of the pressure resistant apparatus.

According to one aspect of the present invention, a pressure resistant apparatus includes a cylindrical body portion, and a lid portion having an annular wall portion, end portions of the body portion and the wall portion being joined to each other to close an opening of the body portion by the lid portion, wherein an annular first groove portion is formed to extend in a peripheral direction on at least one of inner peripheral surfaces of the body portion and the wall portion, and an inner diameter of the first groove portion is larger than inner diameters of the body portion and the end portion of the wall portion.

### BRIEF DESCRIPTION OF DRAWINGS

FIG. 1 is a partial sectional view of a hydraulic cylinder including a cylinder according to a first embodiment of the present invention.

FIG. 2 is an enlarged view of II part in FIG. 1.

FIG. 3 is a view illustrating flow of a force (force line) transmitted from a cylinder bottom to a cylinder tube when a cylinder receives a tensile load, illustrating correspondingly to FIG. 2.

FIG. 4 is an enlarged sectional view of the cylinder according to a variation of the first embodiment of the present invention.

FIG. 5 is an enlarged sectional view of the cylinder according to another variation of the first embodiment of the present invention.

FIG. 6 is an enlarged sectional view of the cylinder according to another variation of the first embodiment of the present invention.

FIG. 7 is an enlarged sectional view of the cylinder according to another variation of the first embodiment of the present invention.

FIG. 8 is an enlarged sectional view of a cylinder according to a second embodiment of the present invention.

FIG. 9 is an enlarged sectional view of the cylinder according to a variation of the second embodiment of the present invention.

FIG. 10 is an enlarged sectional view of the cylinder according to another variation of the second embodiment of the present invention.

FIG. 11 is an enlarged sectional view of the cylinder according to another variation of the second embodiment of the present invention.

FIG. 12 is an enlarged sectional view of the cylinder according to a third embodiment of the present invention.

FIG. 13 is an enlarged sectional view of the cylinder according to a variation of the third embodiment of the present invention.

FIG. 14 is a partial sectional view of a hydraulic cylinder including a cylinder according to a fourth embodiment of the present invention.

FIG. 15 is an enlarged view of XV part in FIG. 14.

FIG. 16 is a view for explaining deformation generated in a positioning portion when the cylinder receives the tensile load.

FIG. 17 is an enlarged sectional view of the cylinder according to a variation of the fourth embodiment of the present invention.

FIG. 18 is an enlarged sectional view of the cylinder according to another variation of the fourth embodiment of the present invention.

FIG. 19 is an enlarged sectional view of the cylinder according to another variation of the fourth embodiment of the present invention.

FIG. 20 is an enlarged sectional view of the cylinder according to another variation of the fourth embodiment of the present invention.

FIG. 21 is an enlarged sectional view of the cylinder according to another variation of the fourth embodiment of the present invention.

FIG. 22 is an enlarged sectional view of the cylinder according to another variation of the fourth embodiment of the present invention.

### DESCRIPTION OF EMBODIMENTS

A pressure resistant apparatus according to embodiments of the present invention will be described below by referring to the attached drawings. The pressure resistant apparatus stores a fluid, and a pressure of the fluid acts on the pressure resistant apparatus from an inside. In the following, a case where the pressure resistant apparatus is any one of cylinders 100, 101, 102, 103, 104, 200, 201, 202, 203, 300, and 301 used for a hydraulic cylinder (fluid pressure cylinder) 1A and a case where it is any one of cylinders 400, 401, 402, 403, 404, 405, and 406 used for a hydraulic cylinder 1B will be described.

### First Embodiment

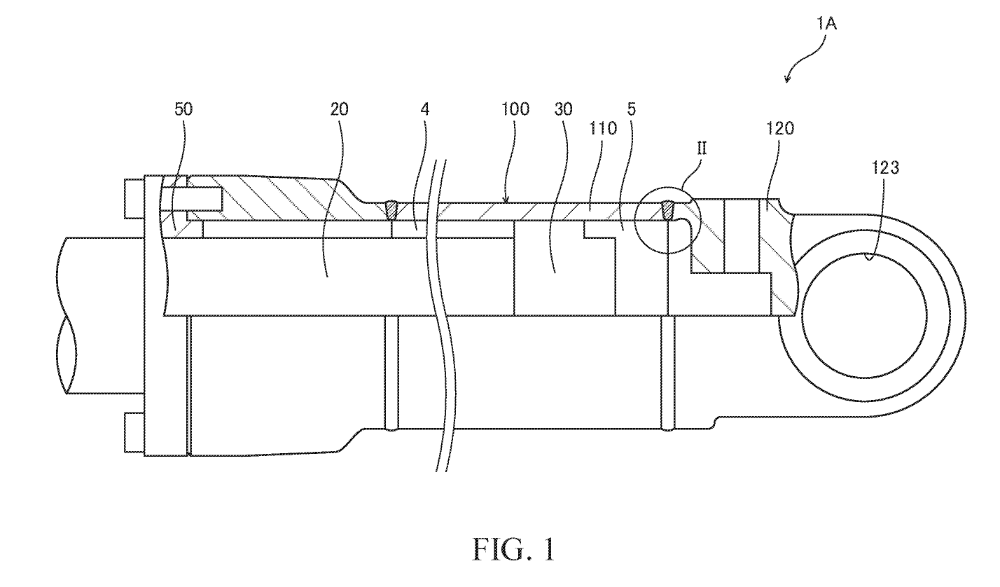

First, the cylinders 100, 101, 102, 103, 104 and the hydraulic cylinder 1A according to a first embodiment of the present invention will be described by referring to FIGS. 1 to 7. As illustrated in FIG. 1, the hydraulic cylinder 1A includes the hollow cylinder 100, a piston rod 20 to be inserted into the cylinder 100, and a piston 30 provided on an end portion of the piston rod 20 and sliding along an inner peripheral surface of the cylinder 100.

An inside of the cylinder 100 is divided by the piston 30 into a rod side chamber 4 and an anti-rod side chamber 5. A working oil as a working fluid is filled in the rod side chamber 4 and the anti-rod side chamber 5.

The hydraulic cylinder 1A is extended by supply of the working oil to the anti-rod side chamber 5 and discharge of the working oil in the rod side chamber 4. Moreover, the hydraulic cylinder 1A is contracted by the supply of the working oil to the rod side chamber 4 and the discharge of the working oil in the anti-rod side chamber 5. When the working oil is supplied to/discharged from the rod side chamber 4 and the anti-rod side chamber 5, a pressure of the working oil acts on the cylinder 100.

The cylinder 100 includes a cylinder tube (a cylindrical body portion) 110 and a cylinder bottom (lid portion) 120 closing one of openings of the cylinder tube 110. The piston rod 20 extends from the cylinder 100 through the other opening of the cylinder tube 110. The other opening of the cylinder tube 110 is closed by a cylinder head 50 slidably supporting the piston rod 20.

In the following, a direction along a center axis of the cylinder tube 110 is referred to as an “axial direction”, a radiating direction around the center axis of the cylinder tube 110 is referred to as a “radial direction”, and a direction along a periphery of the center axis of the cylinder tube 110 is referred to as a “peripheral direction”.

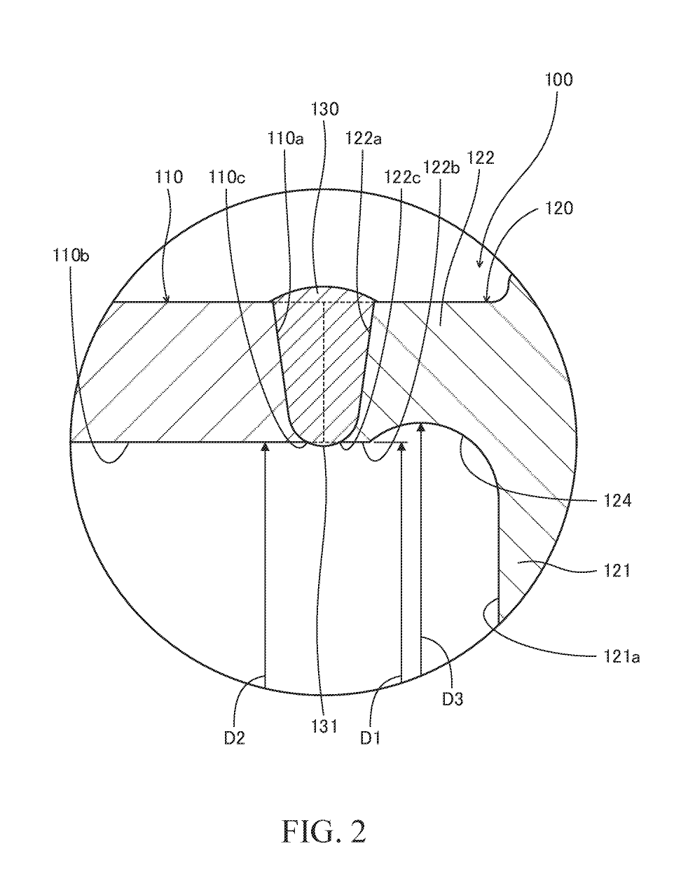

FIG. 2 is an enlarged view of II part in FIG. 1. As illustrated in FIG. 2, the cylinder bottom 120 has a bottom body 121 covering the opening of the cylinder tube 110 and an annular wall portion 122 extending in the axial direction from the bottom body 121. An end surface 121a of the bottom body 121 is faced with the anti-rod side chamber 5 (see FIG. 1). On the bottom body 121, a mounting portion 123 (see FIG. 1) for mounting the hydraulic cylinder 1A on another apparatus is provided.

An inner diameter D1 of a tip end portion (end portion) 122a of the wall portion 122 is substantially equal to an inner diameter D2 of an opening end portion (end portion) 110a of the cylinder tube 110. The tip end portion 122a of the wall portion 122 is joined to the opening end portion 110a of the cylinder tube 110 by welding. For the welding between the cylinder tube 110 and the wall portion 122, arbitrary methods such as arc welding including plasm welding and TIG welding, gas welding, laser welding, electron beam welding, resistance welding, friction welding and the like may be used.

A broken line in FIG. 2 indicates shapes of the cylinder tube 110 and the cylinder bottom 120 before welding. A joint portion 130 is formed by welding the opening end portion 110a of the cylinder tube 110 and the tip end portion 122a of the wall portion 122. By means of the welding between the cylinder tube 110 and the wall portion 122, the cylinder tube 110 and the cylinder bottom 120 are integrated through the joint portion 130.

The joint portion 130 protrudes from an inner peripheral surface 110b of the cylinder tube 110 and an inner peripheral surface 122b of the wall portion 122 in some cases. FIG. 2 illustrates a state where a part of the joint portion 130 protrudes from the inner peripheral surface 110b of the cylinder tube 110 and the inner peripheral surface 122b of the wall portion 122, that is, a state where a projection 131 is formed. Roots 110c and 122c of the projection 131 are formed in the vicinity of an inner periphery of the opening end portion 110a of the cylinder tube 110 and in a vicinity of an inner periphery of the tip end portion 122a of the wall portion 122.

On the inner peripheral surface 122b of the wall portion 122, an annular groove portion (first groove portion) 124 extending in the peripheral direction is formed. A maximum inner diameter D3 (hereinafter, referred to as an “inner diameter D3 of the groove portion 124”) in the groove portion 124 of the wall portion 122 is larger than the inner diameter D1 of the tip end portion 122a of the wall portion 122 and the inner diameter D2 of the opening end portion 110a of the cylinder tube 110.

In the cylinder 100, the groove portion 124 is formed over the entire periphery in the peripheral direction. The groove portion 124 may be formed on a part in the peripheral direction.

A section of the groove portion 124 is formed having a bow shape. The section of the groove portion 124 may be a shape other than the bow shape or a triangular shape, a square shape or the like, for example. The section of the groove portion 124 preferably has a bow shape, and in this case, stress concentration in the groove portion 124 can be relaxed.

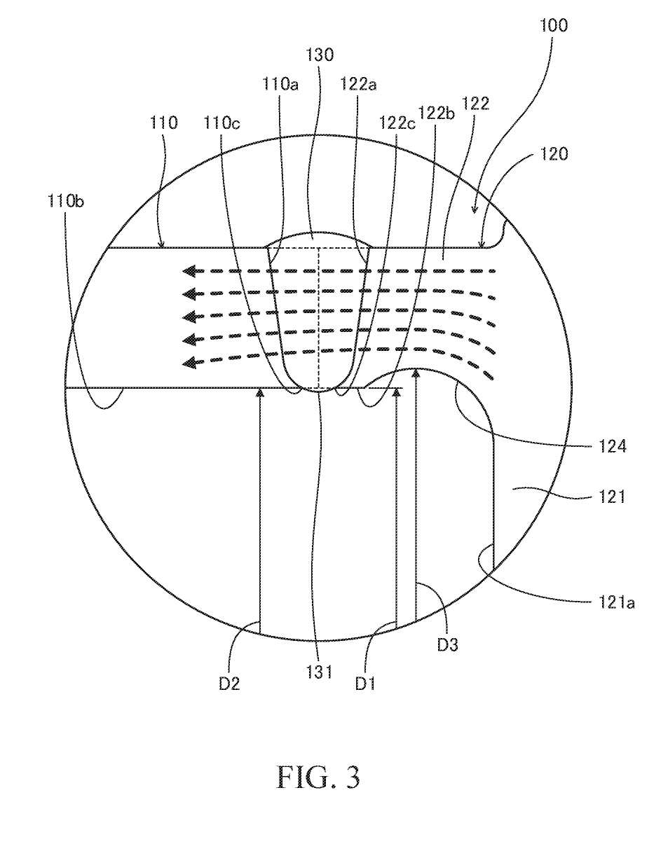

FIG. 3 is a view illustrating a flow of a force (force line) transmitted to the cylinder tube 110 from the cylinder bottom 120 when the cylinder 100 receives a tensile load as an axial force and illustrates it correspondingly to FIG. 2. In FIG. 3, the flow of the force is indicated by a broken line, and hatching indicating the sections of the cylinder tube 110, the cylinder bottom 120, and the joint portion 130 is omitted. The tensile load acts on the cylinder 100 by a pressure of the working oil in the cylinder 100 and a load connected to the hydraulic cylinder 1A, for example.

In the cylinder 100, the annular groove portion 124 is formed on the inner peripheral surface 122b of the wall portion 122. Thus, when the cylinder 100 receives the force in the axial direction, the force acting on the cylinder bottom 120 is transmitted to the cylinder tube 110 mainly via a portion located closer to an outer side in the radial direction than a bottom surface of the groove portion 124 in the wall portion 122.

Since the inner diameter D3 of the groove portion 124 is larger than the inner diameter D1 of the tip end portion 122a of the wall portion 122, the force is not transmitted easily to the inner periphery of the tip end portion 122a in the wall portion 122. Stress concentration generated in the root 122c of the projection 131 can be relaxed, and breakage of the joint portion 130 and the cylinder bottom 120 can be prevented. Therefore, durability of the cylinder 100 can be improved.

Moreover, since the inner diameter D3 of the groove portion 124 is larger than the inner diameter D2 of the opening end portion 110a of the cylinder tube 110, the force is not transmitted easily to the inner periphery of the opening end portion 110a of the cylinder tube 110. The stress concentration generated in the root 110c of the projection 131 can be relaxed, and breakage of the joint portion 130 and the cylinder tube 110 can be prevented. Therefore, durability of the cylinder 100 can be improved.

The pressure of the working oil in the anti-rod side chamber 5 (see FIG. 1) acts on the bottom body 121 of the cylinder bottom 120 in the axial direction. If the groove portion 124 is not formed on the inner peripheral surface 122b of the wall portion 122, a larger force acts on the inner periphery of the tip end portion 122a of the wall portion 122 than on the inner periphery of the opening end portion 110a of the cylinder tube 110. The stress can easily concentrate on the root 110c and the root 122c, and the cylinder bottom 120 can be broken easily.

In the cylinder 100, the groove portion 124 is formed on the inner peripheral surface 122b of the wall portion 122, while the groove portion is not formed on the inner peripheral surface 110b of the cylinder tube 110. The force is transmitted less easily to the inner periphery of the tip end portion 122a of the wall portion 122 than to the inner periphery of the opening end portion 110a of the cylinder tube 110. The stress concentration generated in the root 122c of the projection 131 can be relaxed more reliably, and breakage of the cylinder bottom 120 can be prevented.

Rigidity of the wall portion 122 is lowered by the groove portion 124 formed on the inner peripheral surface 122b of the wall portion 122, and the wall portion 122 can be elastically deformed more easily. Since the wall portion 122 can be deformed more easily in accordance with the deformation of the cylinder tube 110, the stress concentration generated in the roots 110c and 122c of the projection 131 can be relaxed.

The groove portion 124 is formed from the inner peripheral surface 122b of the wall portion 122 to the end surface 121a of the bottom body 121. That is, a curved surface is formed by the groove portion 124 between the inner peripheral surface 122b of the wall portion 122 and the end surface 121a of the bottom body 121. A radius of curvature of the groove portion 124 can be made larger than a case where the curved surface is formed between the inner peripheral surface 122b of the wall portion 122 and the surface of the bottom body 121 without using the groove portion 124, and the stress concentration in the groove portion 124 can be relaxed.

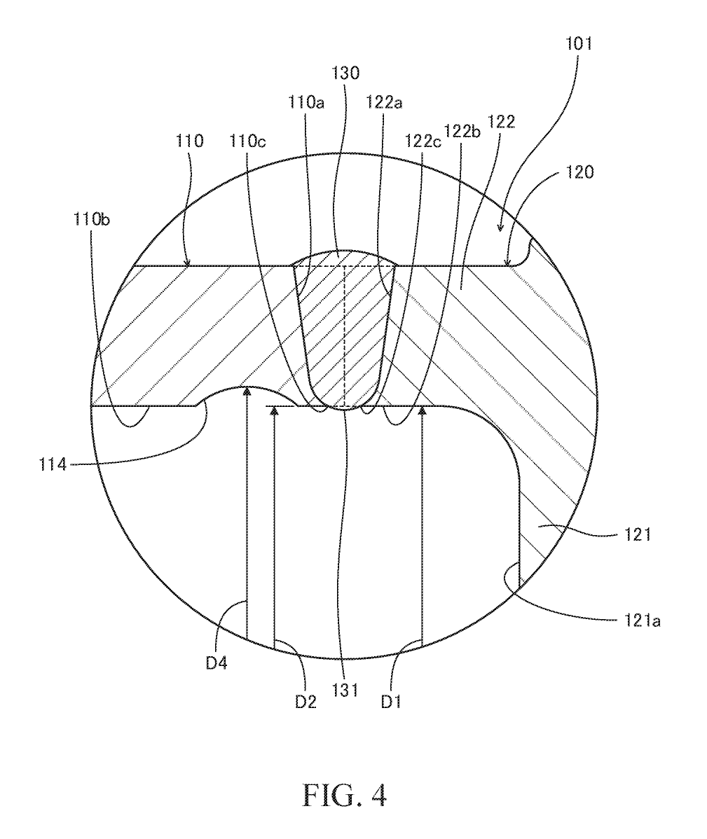

FIG. 4 is an enlarged sectional view illustrating a cylinder 101 according to a variation of the first embodiment. In the cylinder 101, a groove portion (first groove portion) 114 extending in the peripheral direction is formed on the inner peripheral surface 110b of the cylinder tube 110. The groove portion 114 is formed over the entire periphery in the peripheral direction. A maximum inner diameter D4 (hereinafter, referred to as an “inner diameter D4 of the groove portion 114”) in the groove portion 114 of the cylinder tube 110 is larger than the inner diameter D1 of the tip end portion 122a of the wall portion 122 and the inner diameter D2 of the opening end portion 110a of the cylinder tube 110.

The groove portion 114 is not limited to a form formed on the entire periphery but may be formed on a part in the peripheral direction.

A section of the groove portion 114 is formed having a bow shape. The section of the groove portion 114 may be a shape other than the bow shape or may be a triangular shape, a square shape or the like, for example. The section of the groove portion 114 preferably has a bow shape, and in this case, stress concentration in the groove portion 114 can be relaxed.

In the cylinder 101, too, similarly to the cylinder 100, the force is not transmitted easily to the inner periphery of the opening end portion 110a of the cylinder tube 110 and to the inner periphery of the tip end portion 122a of the wall portion 122. The stress concentration generated in the root 110c and the root 122c of the projection 131 can be relaxed, and breakage of the cylinder tube 110, the cylinder bottom 120, and the joint portion 130 can be prevented. Therefore, durability of the cylinder 101 can be improved.

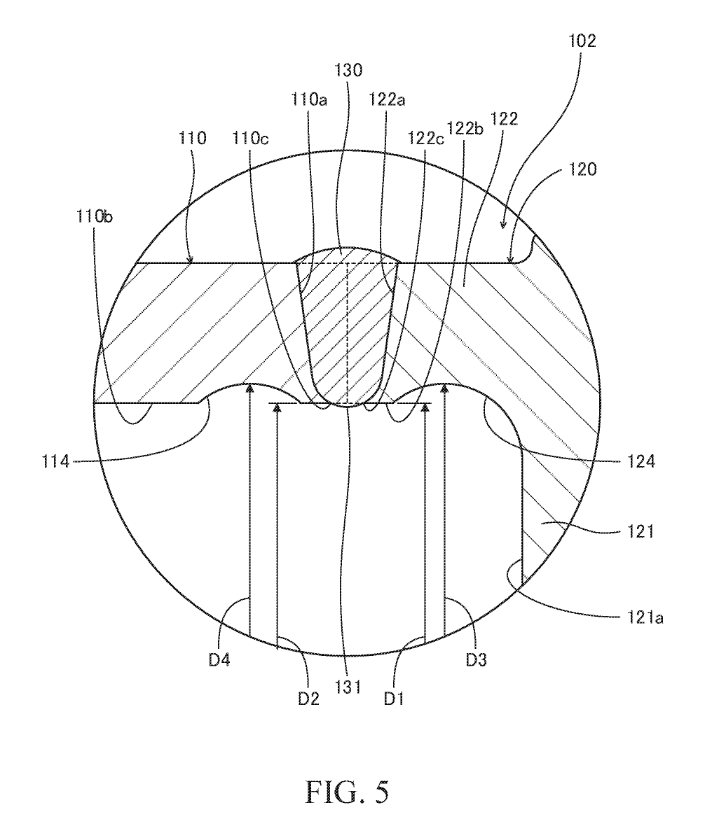

FIG. 5 is an enlarged sectional view illustrating a cylinder 102 according to a variation of the first embodiment. In the cylinder 102, the groove portion (first groove portion) 114 is formed on the inner peripheral surface 110b of the cylinder tube 110, and the groove portion (first groove portion) 124 is formed on the inner peripheral surface 122b of the wall portion 122.

In the cylinder 102, too, similarly to the cylinder 100, 101, the force is not transmitted easily to the inner periphery of the opening end portion 110a of the cylinder tube 110 and to the inner periphery of the tip end portion 122a of the wall portion 122. The stress concentration generated in the root 110c and the root 122c of the projection 131 can be relaxed, and breakage of the cylinder tube 110, the cylinder bottom 120, and the joint portion 130 can be prevented. Therefore, durability of the cylinder 102 can be improved.

In the cylinder 102, too, similarly to the cylinder 100, rigidity of the wall portion 122 is lowered by the groove portion 124 formed on the inner peripheral surface 122b of the wall portion 122. The wall portion 122 can be deformed easily in accordance with the deformation of the cylinder tube 110, and the stress concentration generated in the roots 110c and 122c of the projection 131 can be relaxed.

The groove portion 124 is formed from the inner peripheral surface 122b of the wall portion 122 to the end surface 121a of the bottom body 121. Similarly to the cylinder 100, the radius of curvature of the groove portion 124 can be made larger so that the stress concentration in the groove portion 124 can be relaxed.

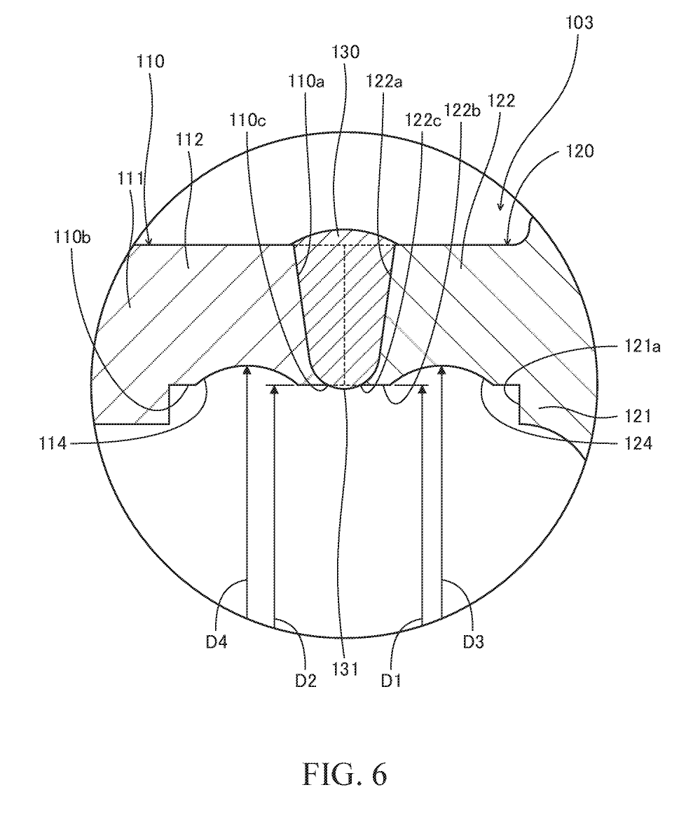

FIG. 6 is a sectional view of the cylinder 103 according to a variation of the first embodiment. In the cylinder 103, the cylinder tube 110 has a tube body 111 accommodating the piston 30 (see FIG. 1) and an annular portion 112 extending annularly in the axial direction from one end of the tube body 111. A tip end portion of the annular portion 112 is the opening end portion 110a of the cylinder tube 110, and an opening of the cylinder tube 110 is formed by the tip end portion of the annular portion 112.

An inner diameter of the tube body 111 is substantially equal to an outer diameter of the piston 30, and the piston 30 is slidable along the inner peripheral surface of the tube body 111. The inner diameter of the tube body 111 corresponds to a so-called cylinder diameter. An inner diameter of the annular portion 112 is larger than the inner diameter of the tube body 111.

The inner diameter of the wall portion 122 of the cylinder bottom 120 is larger than the inner diameter of the tube body 111. The inner diameter D1 of the tip end portion 122a of the wall portion 122 is substantially equal to the inner diameter (inner diameter D2 of the opening end portion 110a of the cylinder tube 110) of the opening end portion 110a of the annular portion 112. The tip end portion 122a of the wall portion 122 and the opening end portion 110a of the annular portion 112 are joined by welding.

The annular groove portion 114 is formed on the inner peripheral surface 110b of the annular portion 112. The inner diameter D4 of the groove portion 114 of the annular portion 112 is larger than the inner diameter D1 of the tip end portion 122a of the wall portion 122 and the inner diameter D2 of the opening end portion 110a of the annular portion 112.

The annular groove portion 124 is formed on the inner peripheral surface 122b of the wall portion 122 of the cylinder bottom 120. The inner diameter D3 of the groove portion 124 of the wall portion 122 is larger than the inner diameter D1 of the tip end portion 122a of the wall portion 122 and the inner diameter D2 of the opening end portion 110a of the annular portion 112.

In the cylinder 103, too, since the inner diameter D4 of the groove portion 114 and the inner diameter D3 of the groove portion 124 are larger than the inner diameter D1 of the tip end portion 122a of the wall portion 122 and the inner diameter D2 of the opening end portion 110a of the annular portion 112, the force is not transmitted easily to the inner periphery of the opening end portion 110a of the annular portion 112 and to the inner periphery of the tip end portion 122a of the wall portion 122. The stress concentration generated in the root 110c and the root 122c of the projection 131 can be relaxed, and breakage of the cylinder tube 110, the cylinder bottom 120, and the joint portion 130 can be prevented. Therefore, durability of the cylinder 103 can be improved.

Moreover, similarly to the cylinder 100, rigidity of the wall portion 122 is lowered by the groove portion 124 formed on the inner peripheral surface 122b of the wall portion 122 and thus, the stress concentration generated in the roots 110c and 122c of the projection 131 can be relaxed.

The cylinder 103 is not limited to a form in which the groove portion 114 and the groove portion 124 are formed on both the inner peripheral surface 110b of the annular portion 112 and the inner peripheral surface 122b of the wall portion 122. The groove portion 114 may be formed only on the inner peripheral surface 110b of the annular portion 112 and the groove portion 124 does not have to be formed on the inner peripheral surface 122b of the wall portion 122. The groove portion 124 may be formed only on the inner peripheral surface 122b of the wall portion 122, and the groove portion 114 does not have to be formed on the inner peripheral surface 110b of the annular portion 112.

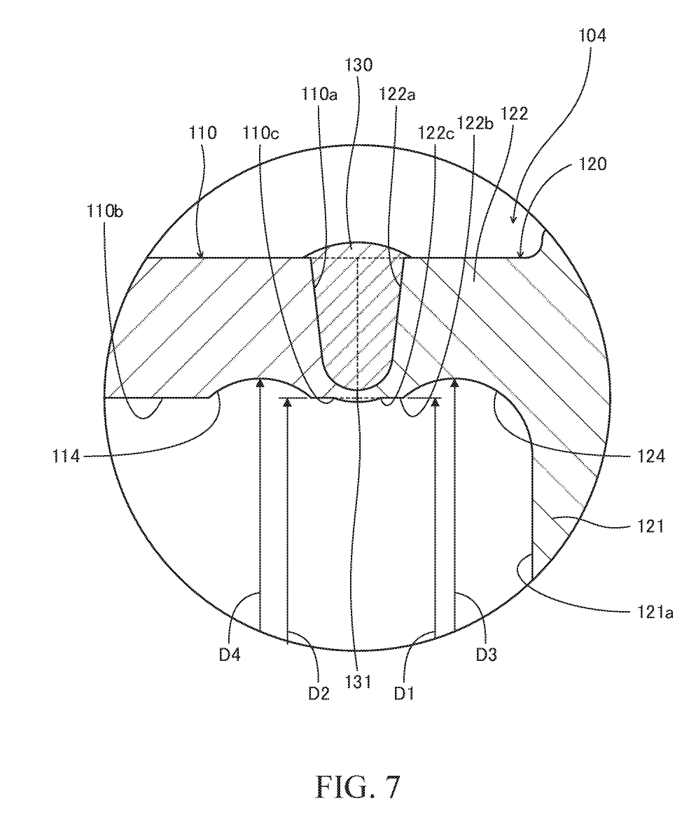

FIG. 7 is a sectional view illustrating the cylinder 104 according to a variation of the first embodiment. In the cylinder 104, a part of the inner peripheral surface 110b of the cylinder tube 110 and a part of the inner peripheral surface 122b of the wall portion 122 are deformed so as to protrude to an inner side in the radial direction. That is, the projection 131 is formed by a part of the cylinder tube 110 and a part of the wall portion 122.

In the cylinder 104, too, the groove portion 124 is formed on the inner peripheral surface 122b of the wall portion 122, and the groove portion 114 is formed on the inner peripheral surface 110b of the cylinder tube 110. The stress concentration generated in the root 110c and the root 122c of the projection 131 can be relaxed, the breakage of the cylinder tube 110 and the cylinder bottom 120 can be prevented. Therefore, durability of the cylinder 104 can be improved.

In the cylinder 104, too, similarly to the cylinder 100, rigidity of the wall portion 122 is lowered by the groove portion 124 formed on the inner peripheral surface 122b of the wall portion 122 and thus, the stress concentration generated in the roots 110c and 122c of the projection 131 can be relaxed. Since the groove portion 124 is formed from the inner peripheral surface 122b of the wall portion 122 to the end surface 121a of the bottom body 121, similarly to the cylinder 100, the radius of curvature of the groove portion 124 can be made larger, whereby the stress concentration in the groove portion 124 can be relaxed.

The cylinder 104 is not limited to a form in which the groove portion 114 and the groove portion 124 are formed on both the inner peripheral surface 110b of the cylinder tube 110 and the inner peripheral surface 122b of the wall portion 122. The groove portion 114 may be formed only on the inner peripheral surface 110b of the cylinder tube 110 and the groove portion 124 does not have to be formed on the inner peripheral surface 122b of the wall portion 122. The groove portion 124 may be formed only on the inner peripheral surface 122b of the wall portion 122, and the groove portion 114 does not have to be formed on the inner peripheral surface 110b of the cylinder tube 110.

### Second Embodiment

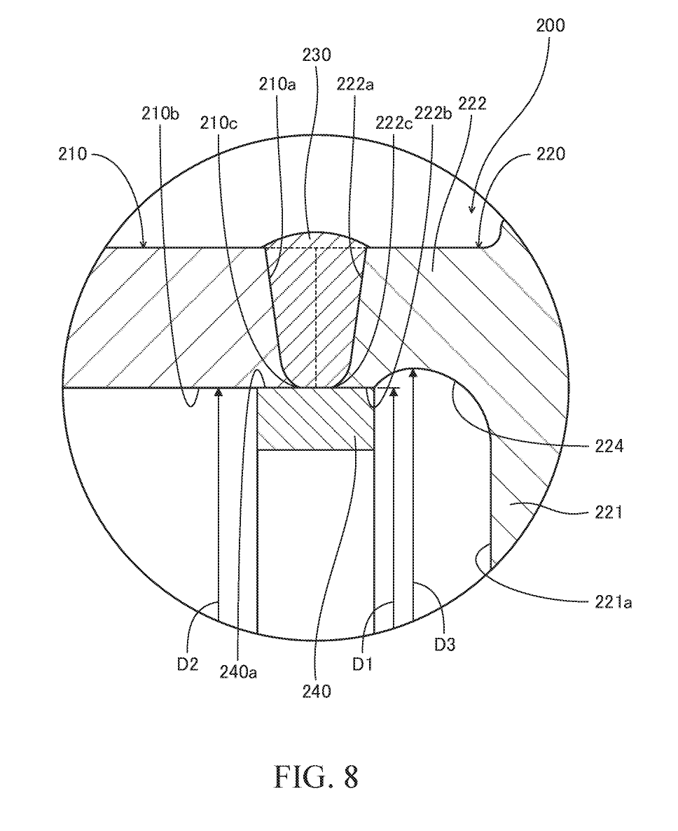

Subsequently, cylinders 200, 201, 202, and 203 according to a second embodiment of the present invention will be described by referring to FIGS. 8 to 11. The same reference numerals are given to the same constitutions as those in the cylinder 100 according to the first embodiment, and the description thereof will be omitted. Moreover, since a hydraulic cylinder to which the cylinders 200, 201, 202, and 203 can be applied is substantially the same as the hydraulic cylinder 1A illustrated in FIG. 1, the illustration is omitted.

As illustrated in FIG. 8, the cylinder 200 includes a cylinder tube 210, a cylinder bottom 220, an annular positioning portion 240 determining relative positions of the cylinder tube 210 and the cylinder bottom 220. The cylinder bottom 220 has a bottom body 221 and an annular wall portion 222. The annular positioning portion 240 is arranged along an inner peripheral surface 210b of the cylinder tube 210 and an inner peripheral surface 222b of the wall portion 222.

The positioning portion 240 is formed separately from the cylinder tube 210 and the wall portion 222 before the cylinder tube 210 and the wall portion 222 are joined. When the cylinder tube 210 and the wall portion 222 are to be joined, first, the cylinder tube 210 and the wall portion 222 are fitted in an outer peripheral surface 240a of the positioning portion 240, and an opening end portion 210a of the cylinder tube 210 and a tip end portion 222a of the wall portion 222 are made to abut to each other. Subsequently, heat is applied to the cylinder tube 210 and the wall portion 222 so as to join the opening end portion 210a and the tip end portion 222a. At this time, the positioning portion 240 is joined to a joint portion 230.

Since the relative positions of the cylinder tube 210 and the wall portion 222 are determined by the positioning portion 240 when the cylinder tube 210 and the wall portion 222 are welded, deviation between the cylinder tube 210 and the wall portion 222 can be prevented. The cylinder tube 210 and the wall portion 222 can be welded in a state where an axis of the cylinder tube 210 and an axis of the wall portion 222 are matched with each other. For the welding between the cylinder tube 210 and the wall portion 222, an arbitrary method such as arc welding including plasma welding and TIG welding, gas welding, laser welding, electron beam welding, resistance welding, friction pressure welding and the like can be used.

A part of the outer peripheral surface 240a of the positioning portion 240 is joined to the joint portion 230, and the other part of the outer peripheral surface 240a is not joined to the joint portion 230. That is, the other part of the outer peripheral surface 240a of the positioning portion 240 is proximate to the cylinder tube 210 and the wall portion 222 without using the joint portion 230.

The entire outer peripheral surface 240a of the positioning portion 240 may be joined to the joint portion 230.

The opening end portion 210a of the cylinder tube 210 and the tip end portion 222a of the wall portion 222 are joined through the joint portion 230, and the positioning portion 240 is joined to the joint portion 230 and thus, the positioning portion 240 corresponds to a projection protruding from the inner peripheral surface 210b and the inner peripheral surface 222b. In other words, the positioning portion 240 corresponds to the projection 131 (see FIG. 2) in the cylinder 100. Bases (roots) 210c and 222c of the positioning portion 240 are formed in the vicinity of the inner periphery of the opening end portion 210a of the cylinder tube 210 and in the vicinity of the inner periphery of the tip end portion 222a of the wall portion 222.

An annular groove portion (first groove portion) 224 is formed on the inner peripheral surface 222b of the wall portion 222. Thus, when the cylinder 200 receives an axial force, the force acting on the cylinder bottom 220 is transmitted to the cylinder tube 210 mainly via a portion located closer to an outer side in the radial direction than a bottom surface of the groove portion 224 in the wall portion 222.

The groove portion 124 may be formed on the entire periphery in the peripheral direction or may be formed on a part in the peripheral direction.

The inner diameter D3 of the groove portion 224 of the wall portion 222 is larger than the inner diameter D1 of the tip end portion 222a of the wall portion 222. The force is not transmitted easily to the inner periphery of the tip end portion 222a of the wall portion 222, and the stress concentration generated in the root 222c can be relaxed, and breakage of the cylinder bottom 220 and the joint portion 230 can be prevented. Therefore, durability of the cylinder 200 can be improved.

Moreover, the inner diameter D3 of the groove portion 224 is larger than the inner diameter D2 of the opening end portion 210a of the cylinder tube 210. The force is not transmitted easily to the inner periphery of the opening end portion 210a of the cylinder tube 210 and the stress concentration generated in the root 210c can be relaxed, and breakage of the cylinder tube 210 and the joint portion 230 can be prevented. Therefore, durability of the cylinder 200 can be improved.

The groove portion 224 is formed on an outer side of a region faced with the positioning portion 240 in the inner peripheral surface 222b of the wall portion 222. Since the positioning portion 240 is in contact with the inner peripheral surface 210b of the cylinder tube 210 and the inner peripheral surface 222b of the wall portion 222 in a wider range, the cylinder tube 210 and the wall portion 222 cannot be deviated easily in the radial direction at joining. Therefore, formation of an unintended stepped part between the cylinder tube 210 and the wall portion 222 can be prevented, and durability of the cylinder 200 can be improved.

In the cylinder 200, too, similarly to the cylinder 100 (see FIG. 2), rigidity of the wall portion 222 is lowered by the groove portion 224 formed on the inner peripheral surface 222b of the wall portion 222, and the wall portion 222 can be deformed easily. Since the wall portion 222 becomes deformable easily in accordance with the deformation of the cylinder tube 210, the stress concentration generated in the roots 210c and 222c of the joint portion 230 can be relaxed more reliably.

The groove portion 224 is formed from the inner peripheral surface 222b of the wall portion 222 to the end surface 221a of the bottom body 221. That is, a curved surface is formed by the groove portion 224 between the inner peripheral surface 222b of the wall portion 222 to the end surface 221a of the bottom body 221. The radius of curvature of the groove portion 224 can be made larger than a case where the curved surface is formed between the inner peripheral surface 222b of the wall portion 222 and a surface of the bottom body 221 without using the groove portion 224, and the stress concentration in the groove portion 224 can be relaxed.

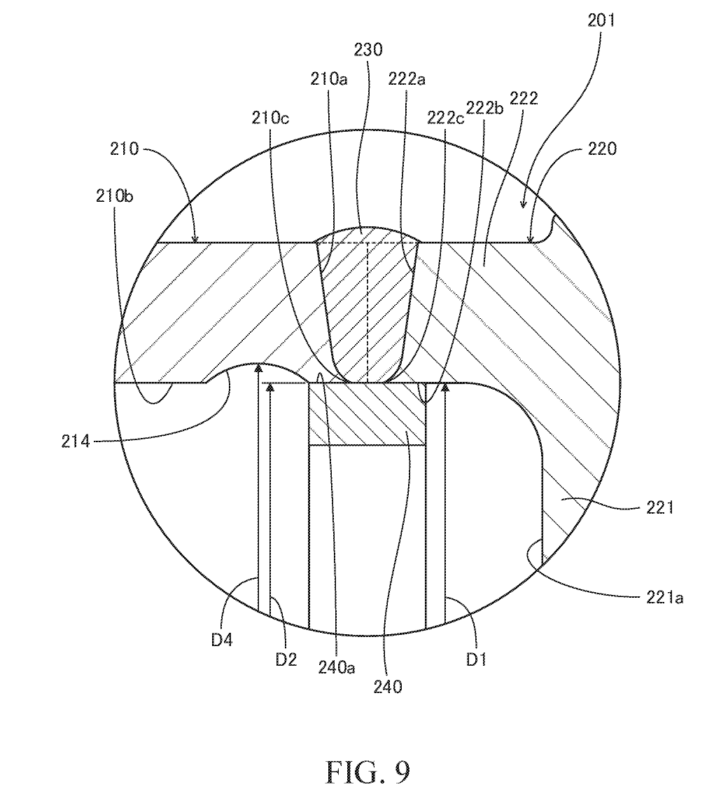

FIG. 9 is an enlarged sectional view illustrating the cylinder 201 according to a variation of the second embodiment. In the cylinder 201, a groove portion (first groove portion) 214 extending in the peripheral direction is formed on the inner peripheral surface 210b of the cylinder tube 210. The groove portion 214 is formed on the entire periphery in the peripheral direction. The inner diameter D4 of the groove portion 214 of the cylinder tube 210 is larger than the inner diameter D1 of the tip end portion 222a of the wall portion 222 and the inner diameter D2 of the opening end portion 210a of the cylinder tube 210.

The groove portion 214 is not limited to a form formed on the entire periphery but may be formed on a part in the peripheral direction.

In the cylinder 201, too, similarly to the cylinder 200, the force is not transmitted easily to the inner periphery of the opening end portion 210a of the cylinder tube 210 and to the inner periphery of the tip end portion 222a of the wall portion 222. The stress concentration generated in the root 210c and the root 222c can be relaxed, and breakage of the cylinder tube 210, the cylinder bottom 220, and the joint portion 230 can be prevented. Therefore, durability of the cylinder 201 can be improved.

The groove portion 214 is formed on the outer side of the region faced with the positioning portion 240 in the inner peripheral surface 210b of the cylinder tube 210. Therefore, similarly to the cylinder 200, the cylinder tube 210 and the wall portion 222 cannot be deviated easily in the radial direction at joining, and durability of the cylinder 201 can be improved.

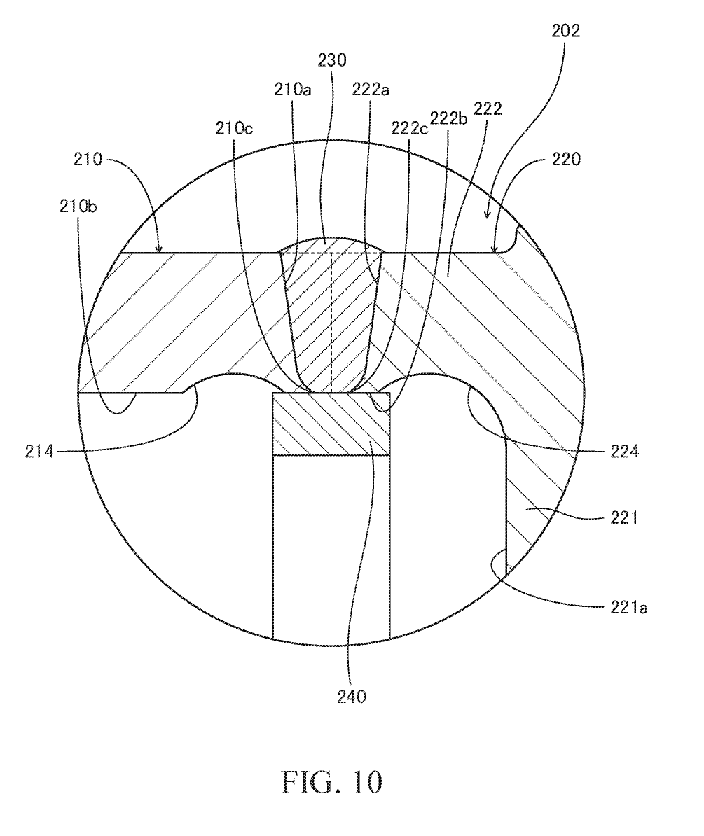

FIG. 10 is an enlarged sectional view illustrating the cylinder 202 according to a variation of the second embodiment. In the cylinder 202, the groove portion 214 is formed on the inner peripheral surface 210b of the cylinder tube 210, and the groove portion 224 is formed on the inner peripheral surface 222b of the wall portion 222. A part of the groove portion 214 is formed in a region faced with the positioning portion 240 in the inner peripheral surface 210b of the cylinder tube 210, and a part of the groove portion 224 is formed in the region faced with the positioning portion 240 in the inner peripheral surface 222b of the wall portion 222.

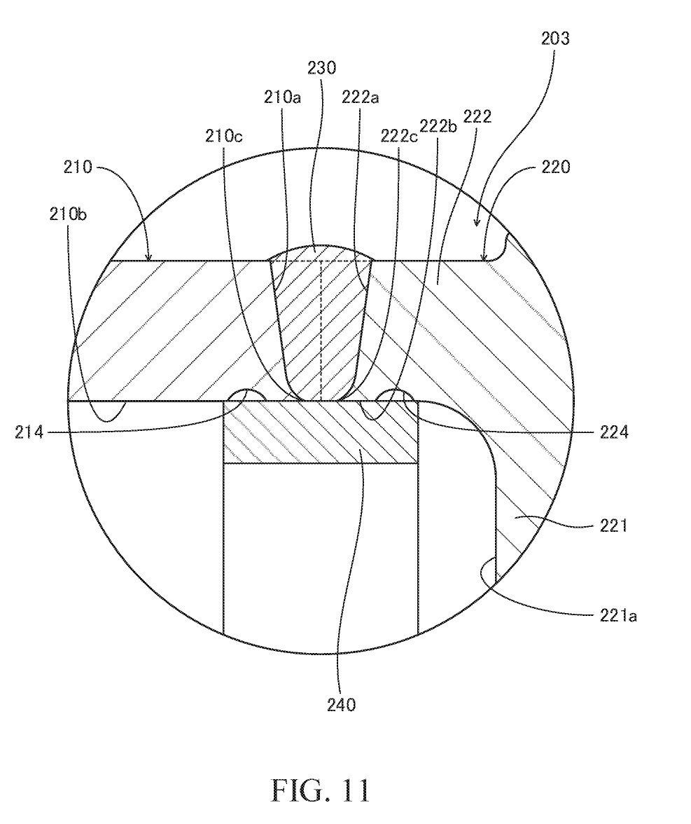

FIG. 11 is an enlarged sectional view illustrating the cylinder 203 according to a variation of the second embodiment. In the cylinder 203, the entire groove portion 214 is formed in the region faced with the positioning portion 240 in the inner peripheral surface 210b of the cylinder tube 210. Moreover, the entire groove portion 224 is formed in the region faced with the positioning portion 240 in the inner peripheral surface 222b of the wall portion 222.

In the cylinder 202 (see FIG. 10) and the cylinder 203 (see FIG. 11), too, similarly to the cylinder 200 and the cylinder 201, the force is not transmitted easily to the inner periphery of the opening end portion 210a of the cylinder tube 210 and to the inner periphery of the tip end portion 222a of the wall portion 222. The stress concentration generated in the root 210c and the root 222c can be relaxed, and breakage of the cylinder tube 210, the cylinder bottom 220, and the joint portion 230 can be prevented. Therefore, durability of the cylinder 202 and the cylinder 203 can be improved.

The cylinder 202 and the cylinder 203 are not limited to a form in which the groove portion 214 and the groove portion 224 are formed on both the inner peripheral surface 210b of the cylinder tube 210 and the inner peripheral surface 222b of the wall portion 222. The groove portion 214 may be formed only on the inner peripheral surface 210b of the cylinder tube 210, and the groove portion 224 does not have to be formed on the inner peripheral surface 222b of the wall portion 222. The groove portion 224 may be formed only on the inner peripheral surface 222b of the wall portion 222, and the groove portion 114 does not have to be formed on the inner peripheral surface 210b of the cylinder tube 210.

In the cylinder 202 and the cylinder 203, too, similarly to the cylinder 200, rigidity of the wall portion 222 is lowered by the groove portion 124 formed on the inner peripheral surface 222b of the wall portion 222. The wall portion 222 can be deformed easily in accordance with the deformation of the cylinder tube 210, and the stress concentration generated in the roots 210c and 222c can be relaxed.

In the cylinder 202, the groove portion 224 is formed from the inner peripheral surface 222b of the wall portion 222 to the end surface 221a of the bottom body 221. Similarly to the cylinder 200, the radius of curvature of the groove portion 224 can be made larger, and the stress concentration in the groove portion 224 can be relaxed.

### Third Embodiment

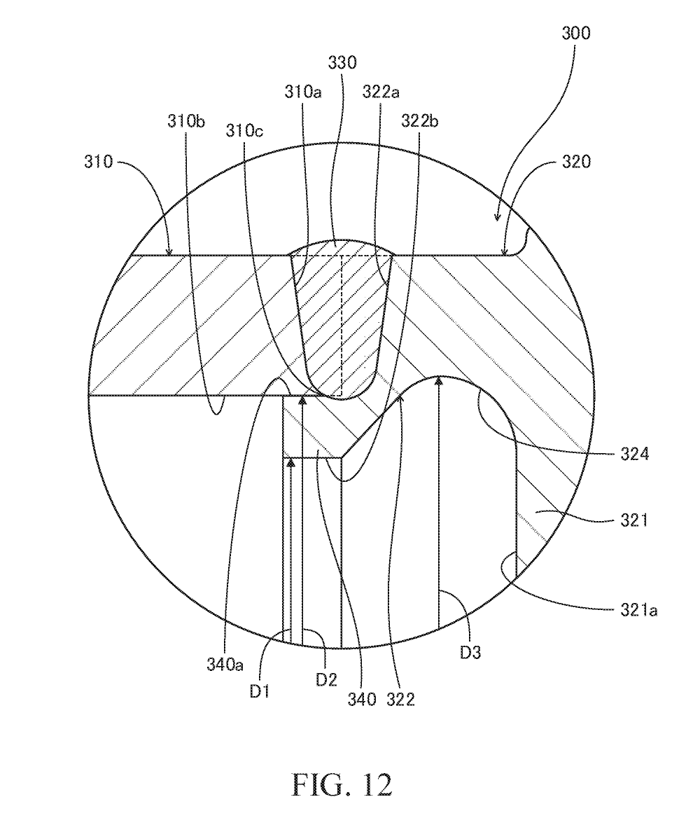

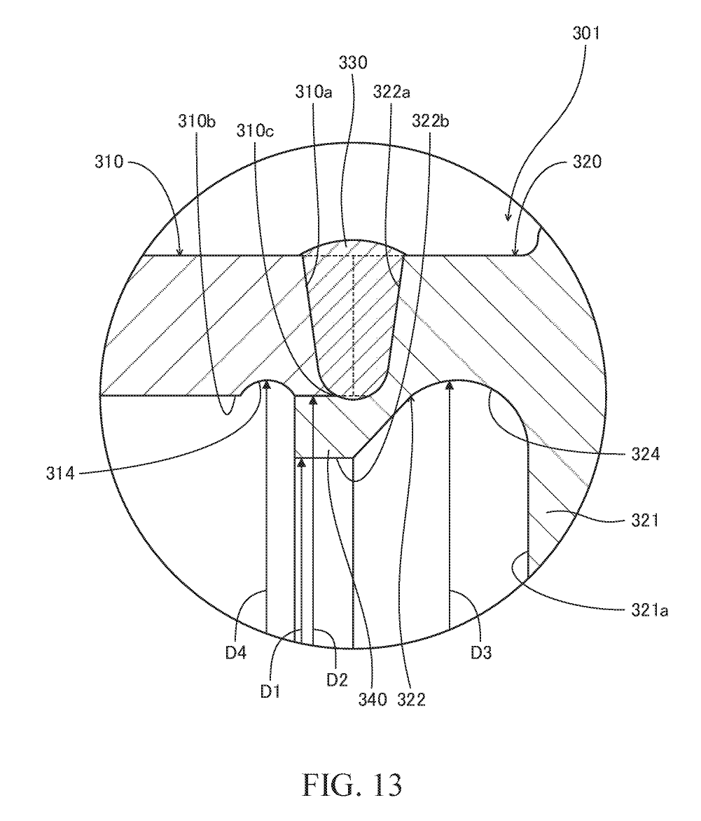

Subsequently, the cylinders 300 and 301 according to a third embodiment of the present invention will be described by referring to FIGS. 12 and 13. The same reference numerals are given to the same constitutions as those in the cylinders 100 and 200 according to the first and second embodiments, and the description will be omitted. Moreover, a hydraulic cylinder to which the cylinders 300 and 301 can be applied is substantially the same as the hydraulic cylinder 1A illustrated in FIG. 1 and thus, the illustration will be omitted.

As illustrated in FIG. 12, the cylinder 300 includes a cylinder tube 310 and a cylinder bottom 320. The cylinder bottom 320 has a bottom body 321 and an annular wall portion 322. The wall portion 322 has a positioning portion 340 determining relative positions of the cylinder tube 310 and the wall portion 322. The positioning portion 340 is arranged along an inner peripheral surface 310b of the cylinder tube 310.

The positioning portion 340 is formed separately from the cylinder tube 310 before the cylinder tube 310 and the wall portion 322 are joined. When the cylinder tube 310 and the wall portion 322 are to be joined, first, the cylinder tube 310 is fitted in an outer peripheral surface 340a of the positioning portion 340, and an opening end portion 310a of the cylinder tube 310 and a tip end portion 322a of the wall portion 322 are made to abut to each other. Subsequently, heat is applied to the cylinder tube 310 and the wall portion 322 so as to join the opening end portion 310a and the tip end portion 322a. At this time, the positioning portion 340 is joined to a joint portion 330.

Since the relative positions of the cylinder tube 310 and the wall portion 322 are determined by the positioning portion 340 when the cylinder tube 310 and the wall portion 322 are joined, deviation between the cylinder tube 310 and the wall portion 322 can be prevented. For the welding between the cylinder tube 310 and the wall portion 322, arbitrary methods such as arc welding including plasm welding and TIG welding, gas welding, laser welding, electron beam welding, resistance welding, friction welding and the like may be used.

Since the positioning portion 340 is formed on the wall portion 322, there is no need to match the wall portion 322 with the position of the positioning portion 340 at joining. Therefore, the cylinder tube 310 and the wall portion 322 can be joined easily, and the cylinder 300 whose durability can be improved can be manufactured easily.

A part of the outer peripheral surface 340a of the positioning portion 340 is joined to the joint portion 330, and the other part of the outer peripheral surface 340a is not joined to the joint portion 330. That is, the other part of the outer peripheral surface 340a of the positioning portion 340 is proximate to the cylinder tube 310 without using the joint portion 330.

The entire outer peripheral surface 340a of the positioning portion 340 may be joined to the joint portion 330.

The opening end portion 310a of the cylinder tube 310 and the tip end portion 322a of the wall portion 322 are joined through the joint portion 330, and the positioning portion 340 is joined to the joint portion 330 and thus, the positioning portion 340 corresponds to a projection protruding from the inner peripheral surface 310b. In other words, the positioning portion 340 corresponds to the projection 131 (see FIG. 2) in the cylinder 100. A base (root) 310c of the positioning portion 340 is formed on the inner periphery of the opening end portion 310a of the cylinder tube 310.

An annular groove portion 324 is formed on the inner peripheral surface 322b of the wall portion 322. Thus, when the cylinder 300 receives an axial force, the force acting on the cylinder bottom 320 is transmitted to the cylinder tube 310 mainly via a portion located closer to an outer side in the radial direction than a bottom surface of the groove portion 324 in the wall portion 322.

The groove portion 324 may be formed on the entire periphery in the peripheral direction or may be formed on a part in the peripheral direction.

The inner diameter D3 of the groove portion 324 of the wall portion 322 is larger than the inner diameter D2 of the opening end portion 310a of the cylinder tube 310. The force is not transmitted easily to the inner periphery of the opening end portion 310a of the cylinder tube 310, and the stress concentration generated in the root 310c can be relaxed, and breakage of the cylinder tube 310 and the joint portion 330 can be prevented. Therefore, durability of the cylinder 300 can be improved.

FIG. 13 is an enlarged sectional view illustrating the cylinder 301 according to a variation of the third embodiment. In the cylinder 301, a groove portion (first groove portion) 314 is formed on the inner peripheral surface 310b of the cylinder tube 310, and a groove portion (first groove portion) 324 is formed on the inner peripheral surface 322b of the wall portion 322. The groove portion 313 and the groove portion 324 may be formed on the entire periphery in the peripheral direction or may be formed on a part in the peripheral direction.

The inner diameter D4 of the groove portion 314 of the cylinder tube 310 is larger than the inner diameter D2 of the opening end portion 310a of the cylinder tube 310. The force is not transmitted easily to the inner periphery of the opening end portion 310a of the cylinder tube 310, and the stress concentration generated in the root 310c of the joint portion 330 can be relaxed more reliably, and breakage of the cylinder tube 310 and the joint portion 330 can be prevented. Therefore, durability of the cylinder 300 can be improved.

The groove portion 314 is formed on the outer side of the region faced with the positioning portion 340 in the inner peripheral surface 310b of the cylinder tube 310. The positioning portion 340 is in contact with the inner peripheral surface 310b of the cylinder tube 310 in a wider range, and the cylinder tube 310 cannot be deviated easily in the radial direction from the wall portion 322 at joining. Therefore, formation of an unintended stepped part between the cylinder tube 310 and the wall portion 322 can be prevented, and durability of the cylinder 301 can be improved.

The cylinder 300 is not limited to a form (see FIG. 12) in which the annular groove portion 324 is formed only on the inner peripheral surface 322b of the wall portion 322. Moreover, the cylinder 300 is not limited to a form (FIG. 13) in which the groove portion 314 and the groove portion 324 are formed on both the inner peripheral surface 310b of the cylinder tube 310 and the inner peripheral surface 322b of the wall portion 322. The groove portion 314 may be formed only on the inner peripheral surface 310b of the cylinder tube 310 and the groove portion 324 does not have to be formed on the inner peripheral surface 322b of the wall portion 322.

In the cylinder 301, the groove portion 314 is formed on the outer side of the region faced with the positioning portion 340 in the inner peripheral surface 310b of the cylinder tube 310. At least a part of the groove portion 314 may be formed in the region faced with the positioning portion 340 in the inner peripheral surface 310b of the cylinder tube 310.

In the cylinder 300 and the cylinder 301, too, similarly to the cylinder 100 (see FIG. 2), rigidity of the wall portion 322 is lowered by the groove portion 324 formed on the inner peripheral surface 322b of the wall portion 322, and the wall portion 322 can be elastically deformed more easily. The wall portion 322 can be deformed more easily in accordance with the deformation of the cylinder 310 and thus, the stress concentration generated in the root 310c of the joint portion 330 can be relaxed.

The groove portion 324 is formed from the inner peripheral surface 322b of the wall portion 322 to the end surface 321a of the bottom body 321. That is, a curved surface is formed by the groove portion 324 between the inner peripheral surface 322b of the wall portion 322 and the end surface 321a of the bottom body 321. The radius of curvature of the groove portion 324 can be made larger than a case where the curved surface is formed between the inner peripheral surface 322b of the wall portion 322 and a surface of the bottom body 321 without using the groove portion 324, and the stress concentration in the groove portion 324 can be relaxed.

In the cylinder 300 and the cylinder 301, the wall portion 322 has the positioning portion 340, and the positioning portion 340 is arranged along the inner periphery of the inner peripheral surface 310b of the cylinder tube 3210. The positioning portion 340 may be provided integrally with the cylinder tube 310 and arranged along the inner peripheral surface 322b of the wall portion 322.

### Fourth Embodiment

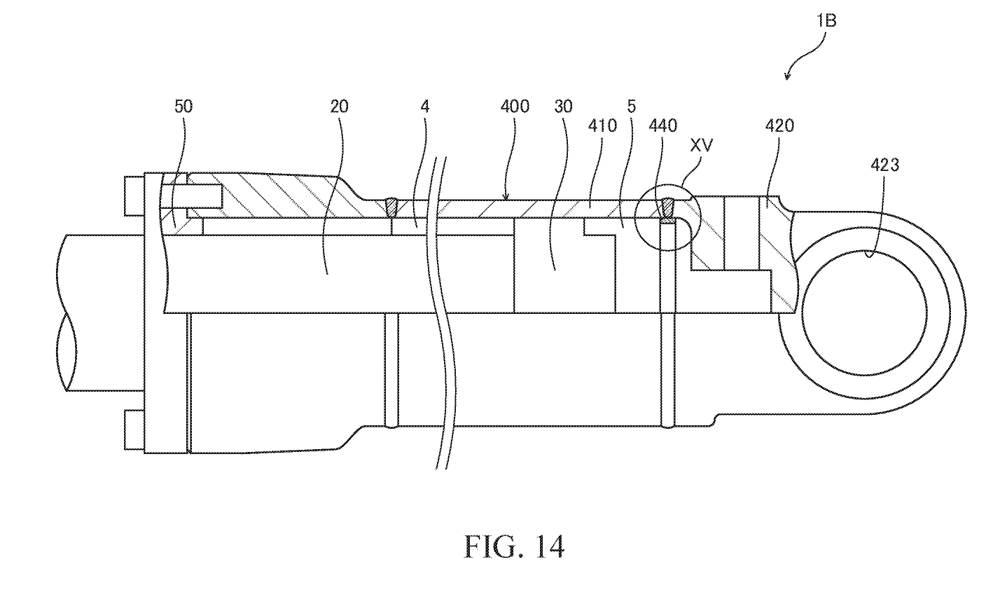

Subsequently, the cylinders 400, 401, 402, 403, 404, 405, and 406 and the hydraulic cylinder 1B according to a fourth embodiment of the present invention will be described by referring to FIGS. 14 to 22. As illustrated in FIG. 14, the hydraulic cylinder 1B includes a hollow cylinder 400, the piston rod 20 inserted into the cylinder 400, and the piston 30 provided on the end portion of the piston rod 20 and sliding along an inner peripheral surface of the cylinder 400.

An inside of the cylinder 400 is divided by the piston 30 into the rod side chamber 4 and the anti-rod side chamber 5. The working oil as the working fluid is filled in the rod side chamber 4 and the anti-rod side chamber 5.

The hydraulic cylinder 1B is extended by supply of the working oil to the anti-rod side chamber 5 and by discharge of the working oil in the rod side chamber 4. Moreover, the hydraulic cylinder 1B is contracted by the supply of the working oil to the rod side chamber 4 and the discharge of the working oil in the anti-rod side chamber 5. When the working oil is supplied to/discharged from the rod side chamber 4 and the anti-rod side chamber 5, a pressure of the working oil acts on the cylinder 400.

The cylinder 400 includes a cylinder tube (a cylindrical body portion) 410, a cylinder bottom (lid portion) 420 closing one of openings of the cylinder tube 410, and an annular positioning portion 440 determining relative positions of the cylinder tube 410 and the cylinder bottom 420. The piston rod 20 extends from the cylinder 400 through the other opening of the cylinder tube 410. The other opening of the cylinder tube 410 is closed by the cylinder head 50 slidably supporting the piston rod 20.

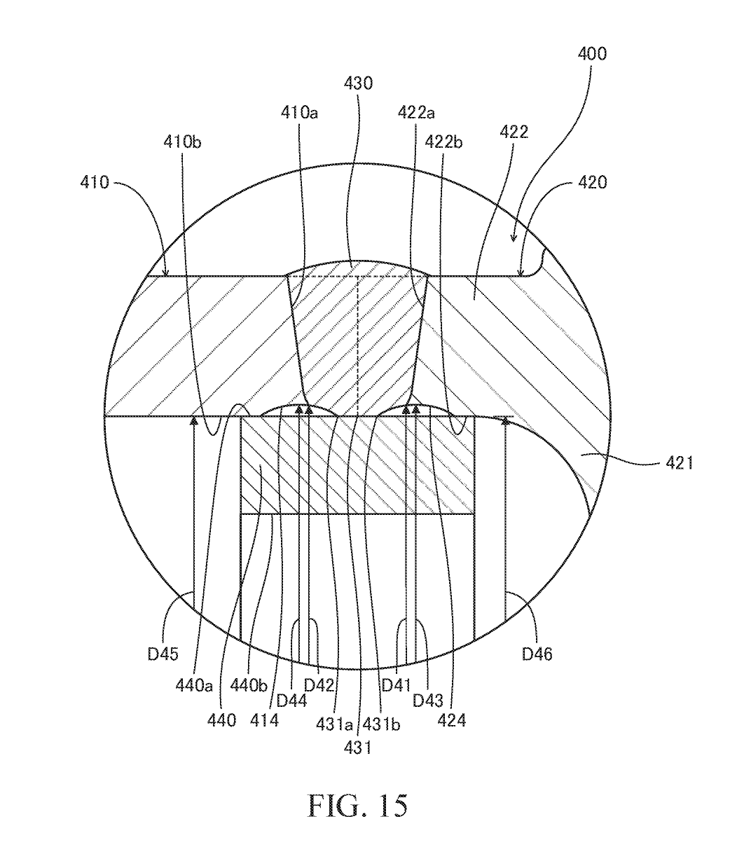

FIG. 15 is an enlarged view of an XV part in FIG. 14. As illustrated in FIG. 15, the cylinder bottom 420 has a bottom body 421 covering the opening of the cylinder tube 410 and an annular wall portion 422 extending in the axial direction from the bottom body 421. On the bottom body 421, a mounting portion 423 (see FIG. 14) for mounting the hydraulic cylinder 1B on another apparatus is provided.

A tip end portion 422a of the wall portion 422 is joined to the opening end portion 410a of the cylinder tube 410 by welding. For the welding between the cylinder tube 410 and the wall portion 422, arbitrary methods such as arc welding including plasm welding and TIG welding, gas welding, laser welding, electron beam welding, resistance welding, friction welding and the like can be used.

A broken line in FIG. 15 indicates shapes of the cylinder tube 410 and the cylinder bottom 420 before welding. A joint portion 430 is formed by welding the opening end portion 410a of the cylinder tube 410 and the tip end portion 422a of the wall portion 422. By means of the welding between the cylinder tube 410 and the wall portion 422, the cylinder tube 410 and the cylinder bottom 420 are integrated through the joint portion 430.

The annular positioning portion 440 is arranged along the inner peripheral surface 410b of the cylinder tube 410 and an inner peripheral surface 422b of the wall portion 422. The positioning portion 440 is formed separately from the cylinder tube 410 and the wall portion 422 before the cylinder tube 410 and the wall portion 422 are joined.

When the cylinder tube 410 and the wall portion 422 are to be joined, first, the cylinder tube 410 and the wall portion 422 are fitted in an outer peripheral surface 440a of the positioning portion 440, and an opening end portion 410a of the cylinder tube 410 and the tip end portion 422a of the wall portion 422 are made to abut to each other. Subsequently, heat is applied to the cylinder tube 410 and the wall portion 422 so as to join the opening end portion 410a and the tip end portion 422a. At this time, the outer peripheral surface 440a of the positioning portion 440 is joined to the joint portion 430.

Since the relative positions of the cylinder tube 410 and the wall portion 422 are determined by the positioning portion 440 when the cylinder tube 410 and the wall portion 422 are welded, deviation between the cylinder tube 410 and the wall portion 422 can be prevented. The cylinder tube 410 and the wall portion 422 can be welded in a state where an axis of the cylinder tube 410 and an axis of the wall portion 422 are matched with each other.

The joint portion 430 is joined to only a part of the outer peripheral surface 440a of the positioning portion 440. That is, a joint surface 431 between the joint portion 430 and the positioning portion 440 is a part of the outer peripheral surface 440a of the positioning portion 440, and both edges 431a and 431b of the joint surface 431 in the axial direction are located on the outer peripheral surface 440a of the positioning portion 440.

On the inner peripheral surface 410b of the cylinder tube 410, an annular groove portion (first groove portion) 414 extending in the peripheral direction is formed. On the inner peripheral surface 422b of the wall portion 422, an annular groove portion (second groove portion) 424 extending in the peripheral direction is formed. Sections of the groove portions 414 and 424 are formed having a bow shape. The groove portion 414 and the groove portion 424 may be formed on the entire periphery in the peripheral direction or may be formed on a part in the peripheral direction.

A part of the bottom surface of the groove portion 414 is formed by the joint portion 430. That is, the joint portion 430 is faced with the groove portion 414. Thus, a position of the one edge 431a of the joint surface 431 is determined by the groove portion 414.

A part of the bottom surface of the groove portion 424 is formed by the joint portion 430. That is, the joint portion 430 is faced with the groove portion 424. Thus, a position of the other edge 431b of the joint surface 431 is determined by the groove portion 424.

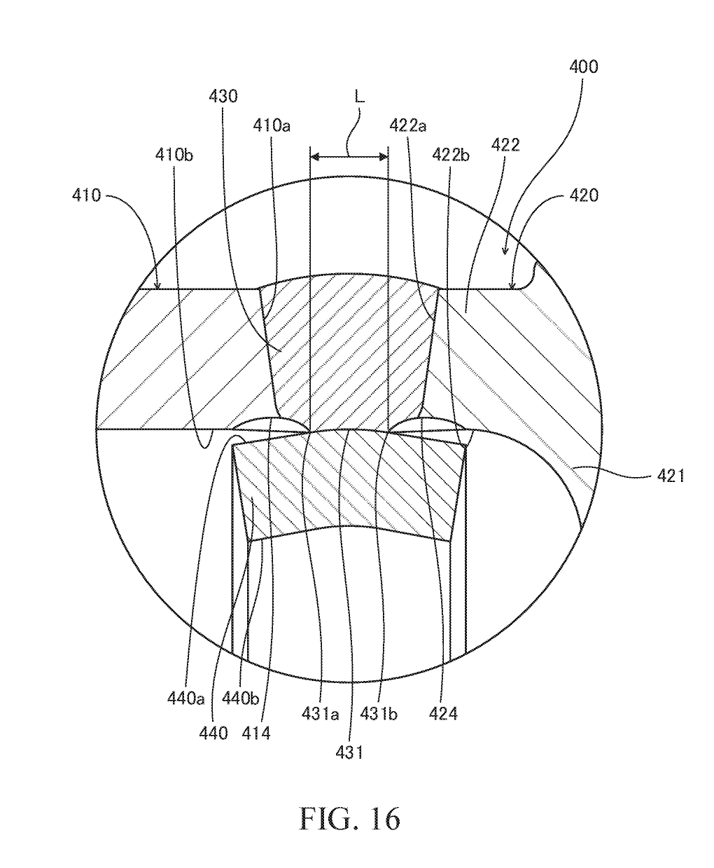

FIG. 16 is a view for explaining deformation generated in the positioning portion 440 when the cylinder 400 receives a tensile load as a force in the axial direction and illustrates it correspondingly to FIG. 15. The tensile load acts on the cylinder 400 by a pressure of the working oil in the cylinder 400 and a load connected to the hydraulic cylinder 1B, for example.

A part of the outer peripheral surface 440a of the positioning portion 440 is joined to the joint portion 430, and the inner peripheral surface 440b of the positioning portion 440 is not joined to the joint portion 430. When the cylinder 400 receives the tensile load, a part of the outer peripheral surface 440a of the positioning portion 440 is extended with the joint portion 430, while the inner peripheral surface 440b of the positioning portion 440 is rarely extended. Thus, the positioning portion 440 is curved so that a center part in the axial direction protrudes to the outer side in the radial direction.

With the curving of the positioning portion 440, the joint portion 430 receives a force in the radial direction from the positioning portion 440. Specifically, since the positioning portion 440 is deformed so that both end portions of the positioning portion 440 are separated away from the cylinder tube 410 and the wall portion 422, an inward force in the radial direction acts on the both edges 431a and 431b of the joint surface 431.

If the groove portion 414 and the groove portion 424 are not formed on the inner peripheral surface 410b of the cylinder tube 410 and the inner peripheral surface 422b of the wall portion 422, the joint surface 431 can be enlarged in the axial direction depending on a welding condition, and the outer peripheral surface 440a of the positioning portion 440 can be joined to the joint portion 430 across an intended range in some cases. If a width (joint width) L of the joint surface 431 in the axial direction is enlarged, the positioning portion 440 is largely deformed by the tensile load received by the cylinder 400. As a result, a larger radial inward force acts on the both edges 431a and 431b of the joint surface 431. As the radial force increases, a stress on the both edges 431a and 431b of the joint surface 431 is increased, and the joint portion 430 becomes easily breakable. As a result, durability of the cylinder 400 is lowered.

In the cylinder 400, since the groove portion 414 is formed on the inner peripheral surface 410b of the cylinder tube 410 and the joint portion 430 is faced with the groove portion 414, a position of the edge 431a of the joint surface 431 is determined by the groove portion 414. The joint surface 431 is not enlarged to a side of the cylinder tube 410 regardless of the welding condition, and a deformation amount of the positioning portion 440 is not increased. An increase of the radial inward force acting on the edge 431a of the joint surface 431 can be prevented, and an increase in the stress in the edge 431a of the joint surface 431 can be prevented. Therefore, breakage of the joint portion 430 can be prevented, and durability of the cylinder 400 can be improved.

Similarly, since the groove portion 424 is formed on the inner peripheral surface 422b of the wall portion 422, and the joint portion 430 is faced with the groove portion 424, a position of the edge 431b of the joint surface 431 is determined by the groove portion 424. The joint surface 431 is not enlarged to a side of the cylinder bottom 420 regardless of the welding condition, and the deformation amount of the positioning portion 440 is not increased. Therefore, an increase in the stress in the edge 431b of the joint surface 431 can be prevented, and durability of the cylinder 400 can be improved.

In the cylinder 400, since the groove portions 414 and 424 are provided on both sides of the joint portion 430 in the axial direction, the position of the both edges 431a and 431b of the joint surface 431 are determined by the groove portions 414 and 424. The enlargement of the joint surface 431 can be prevented more reliably regardless of the welding condition, and an increase in the stress in the edges 431a and 431b of the joint surface 431 can be prevented. Therefore, durability of the cylinder 400 can be improved.

Refer to FIG. 15. An inner diameter D41 of the tip end portion (end portion) 422a of the wall portion 422 is substantially equal to an inner diameter D42 of the opening end portion (end portion) 410a of the cylinder tube 410. A maximum inner diameter D43 (hereinafter, referred to as an “inner diameter D43 of the groove portion 424”) in the groove portion 424 of the wall portion 422 is larger than the inner diameter D41 of the tip end portion 422a of the wall portion 422 and the inner diameter D42 of the opening end portion 410a of the cylinder tube 410. Moreover, a maximum inner diameter D44 (hereinafter, referred to as an “inner diameter D44 of the groove portion 414”) in the groove portion 414 of the cylinder tube 410 is larger than the inner diameter D41 of the tip end portion 422a of the wall portion 422 and the inner diameter D42 of the opening end portion 410a of the cylinder tube 410.

In the cylinder 400, the joint portion 430 is joined to the positioning portion 440 and is faced with the groove portion 414 formed on the inner peripheral surface 410b of the cylinder tube 410. The inner diameter D44 of the groove portion 414 of the cylinder tube 410 is larger than an inner diameter D45 of the edge 431a of the joint surface 431.

Similarly, the joint portion 430 is joined to the positioning portion 440 and is faced with the groove portion 424 formed on the inner peripheral surface 422b of the wall portion 422. An inner diameter D43 of the groove portion 424 of the wall portion 422 is larger than an inner diameter D46 of the edge 431b of the joint surface 431.

When the cylinder 400 receives an axial force, the force acting on the cylinder tube 410 and the cylinder bottom 420 is transmitted to the cylinder bottom 420 and the cylinder tube 410 mainly via a portion located closer to an outer side in the radial direction than bottom surfaces of the groove portions 414 and 424 in the joint portion 430. Since the inner diameters D44 and D43 of the groove portions 414 and 424 are larger than the inner diameters D45 and D46 of the edges 431a and 431b of the joint surface 431, the force is not transmitted easily to the edges 431a and 431b of the joint surface 431. The stress concentration generated in the edges 431a and 431b of the joint surface 431 can be relaxed, and fatigue destruction of the joint portion 430 by a repetitious load can be prevented. Therefore, durability of the cylinder 400 can be improved.

The groove portion 414 is formed in the region faced with the positioning portion 440 in the inner peripheral surface 410b of the cylinder tube 410. That is, in a state where the cylinder 400 does not receive a tensile load, the groove portion 414 is sealed by the outer peripheral surface 440a of the positioning portion 440. Similarly, the groove portion 424 is formed in the region faced with the positioning portion 440 in the inner peripheral surface 422b of the wall portion 422. That is, in a state where the cylinder 400 does not receive a tensile load, the groove portion 424 is sealed by the outer peripheral surface 440a of the positioning portion 440.

Since the groove portion 414 and the groove portion 424 are sealed by the outer peripheral surface 440a of the positioning portion 440, the both ends of the positioning portion 440 in the axial direction are brought into contact with the cylinder tube 410 and the wall portion 422 at welding. Deviation between the cylinder tube 410 and the wall portion 422 in the radial direction at joining can be prevented more reliably, and formation of an unintended stepped part between the cylinder tube 410 and the wall portion 422 can be prevented. Therefore, durability of the cylinder 400 can be improved.

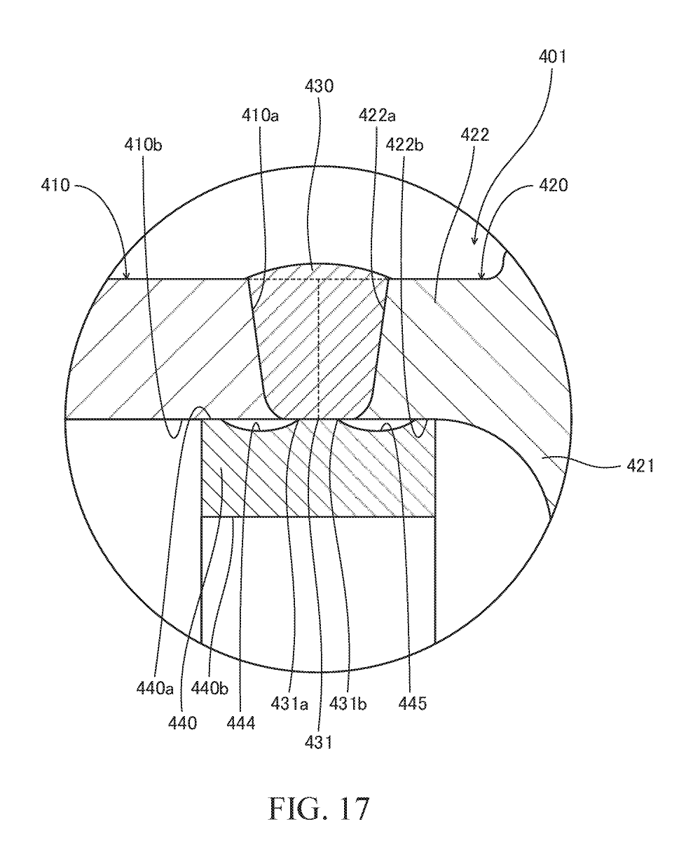

FIG. 17 is an enlarged sectional view illustrating the cylinder 401 according to a variation of this embodiment. In the cylinder 401, annular groove portions (second groove portions) 444 and 445 are formed on the outer peripheral surface 440a of the positioning portion 440. Sections of the groove portions 444 and 445 are formed having a bow shape. The groove portion 444 and the groove portion 445 may be formed over the entire periphery in the peripheral direction or may be formed on a part in the peripheral direction.

The groove portion 444 is covered by the cylinder tube 410 and the joint portion 430. That is, the joint portion 430 is faced with the groove portion 444. Thus, the position of the one edge 431a of the joint surface 431 is determined by the groove portion 444.

Similarly, the groove portion 445 is covered by the wall portion 422 and the joint portion 430. That is, the joint portion 430 is faced with the groove portion 445. Thus, the position of the other edge 431b of the joint surface 431 is determined by the groove portion 445.

In the cylinder 401, too, similarly to the cylinder 400, the joint surface 431 is not enlarged regardless of the welding condition, and the deformation amount of the positioning portion 440 when the cylinder 401 receives a tensile load is not increased. Therefore, an increase in the stress in the edges 431a and 431b of the joint surface 431 can be prevented, and durability of the cylinder 401 can be improved.

In the cylinder 401, the groove portion 414 (see FIG. 15) is not formed on the inner peripheral surface 410b of the cylinder tube 410, and the groove portion 424 (see FIG. 15) is not formed on the inner peripheral surface 422b of the wall portion 422. Thus, thicknesses of the cylinder tube 410 and the wall portion 422 can be made constant. Therefore, brittle fracture of the cylinder tube 410 and the wall portion 422 caused by a large load received by the cylinder 401 can be prevented.

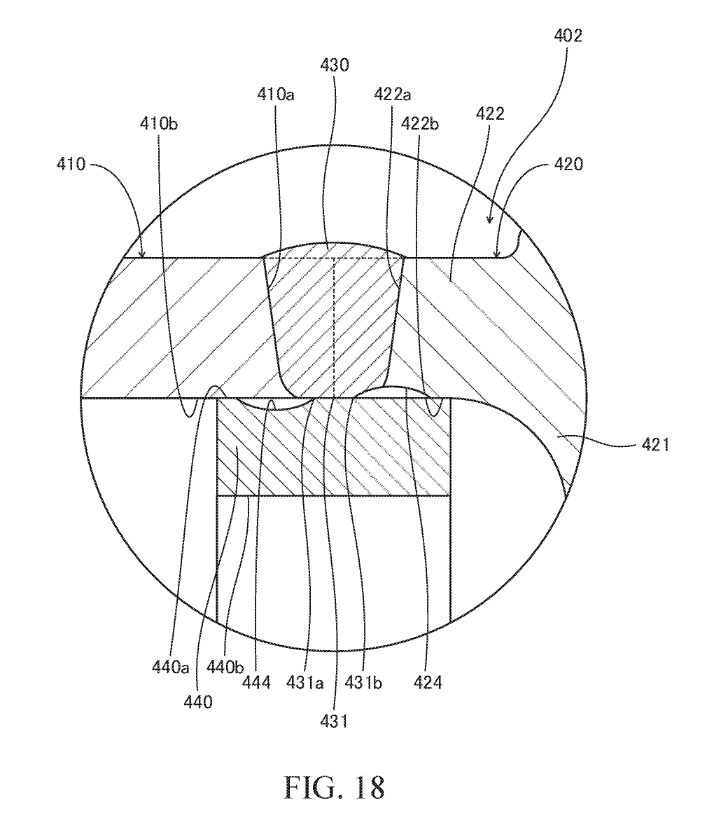

FIG. 18 is an enlarged sectional view illustrating the cylinder 402 according to another variation of this embodiment. In the cylinder 402, the groove portion (first groove portion) 424 is formed on the inner peripheral surface 422b of the wall portion 422, and the groove portion (second groove portion) 444 is formed on the outer peripheral surface 440a of the positioning portion 440.

In the cylinder 402, too, similarly to the cylinder 400, the positions of the edges 431a and 431b of the joint surface 431 are determined by the groove portions 424 and 444. The joint surface 431 is not enlarged regardless of the welding condition, and the deformation amount of the positioning portion 440 when the cylinder 402 receives a tensile load is not increased. Therefore, an increase in the stress in the edges 431a and 431b of the joint surface 431 can be prevented, and durability of the cylinder 402 can be improved.

In the cylinder 402, the groove portion 414 (see FIG. 15) is not formed on the inner peripheral surface 410b of the cylinder tube 410. Thus, the thickness of the cylinder tube 410 can be made constant. Therefore, the brittle fracture of the cylinder tube 410 caused by the large load received by the cylinder 402 can be prevented.

Moreover, in the cylinder 402, the groove portion 424 is formed on the inner peripheral surface 422b of the wall portion 422. Thus, when the cylinder 402 receives an axial force, the force acting on the cylinder bottom 420 is transmitted to the cylinder tube 410 mainly via a portion located closer to the outer side in the radial direction than the bottom surface of the groove portion 424 in the wall portion 422.

On the bottom body 421 of the cylinder bottom 420, the pressure of the working oil in the anti-rod side chamber 5 (see FIG. 14) acts in the axial direction. If the groove portion 424 is not formed on the inner peripheral surface 422b of the wall portion 422, a larger force acts on the edge 431b of the joint surface 431 than on the edge 431a of the joint surface 431, and the cylinder bottom 420 can be broken easily.

In the cylinder 402, the groove portion 424 is formed on the inner peripheral surface 422b of the wall portion 422, while the groove portion 414 (see FIG. 15) is not formed on the inner peripheral surface 410b of the cylinder tube 410. As compared with the edge 431a of the joint surface 431, the force is transmitted less easily to the edge 431b of the joint surface 431. The stress concentration generated in the edge 431b of the joint surface 431 can be relaxed more reliably, and fatigue destruction of the joint portion 430 caused by the repetitious load can be prevented.

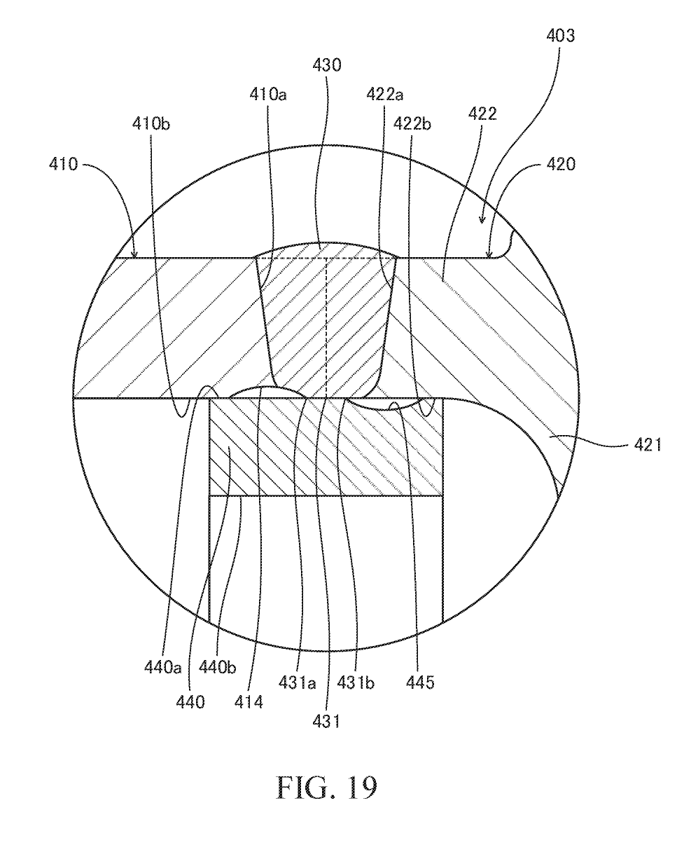

FIG. 19 is an enlarged sectional view illustrating the cylinder 403 according to another variation of this embodiment. In the cylinder 403, the groove portion (first groove portion) 414 is formed on the inner peripheral surface 410b of the cylinder tube 410, and the groove portion (second groove portion) 445 is formed on the outer peripheral surface 440a of the positioning portion 440.

In the cylinder 403, too, similarly to the cylinder 400, the positions of the edges 431a and 431b of the joint surface 431 are determined by the groove portions 414 and 445. The joint surface 431 is not enlarged regardless of the welding condition, and the deformation amount of the positioning portion 440 when the cylinder 403 receives a tensile load is not increased. Therefore, an increase in the stress in the edges 431a and 431b of the joint surface 431 can be prevented, and durability of the cylinder 403 can be improved.

In the cylinder 403, the groove portion 424 (see FIG. 15) is not formed on the inner peripheral surface 422b of the wall portion 422. Thus, thicknesses of the wall portion 422 can be made constant. Therefore, brittle fracture of the wall portion 422 caused by a large load received by the cylinder 403 can be prevented.

Moreover, in the cylinder 403, the groove portion 424 is formed on the inner peripheral surface 410b of the cylinder tube 410. Thus, when the cylinder 403 receives an axial force, the force acting on the cylinder tube 410 is transmitted to the cylinder bottom 420 mainly via a portion located closer to an outer side in the radial direction than the bottom surface of the groove portion 414 in the cylinder tube 410. The force is not transmitted easily to the edges 431a and 431b of the joint surface 431, and the stress concentration generated in the edges 431a and 431b of the joint surface 431 can be relaxed. Therefore, fatigue destruction of the joint portion 430 by a repetitious load can be prevented.

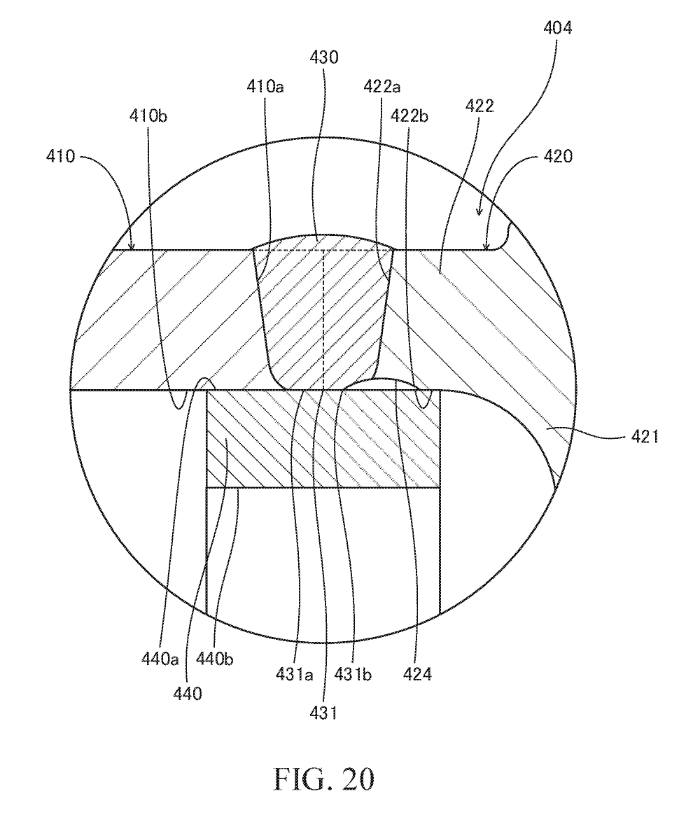

FIG. 20 is an enlarged sectional view illustrating the cylinder 404 according to another variation of this embodiment. In the cylinder 404, the groove portion (first groove portion) 424 is formed on the inner peripheral surface 422b of the wall portion 422. The groove portions 414, 444, and 445 (see FIG. 15 and FIG. 17) are not formed on the inner peripheral surface 410b of the cylinder tube 410 and the outer peripheral surface 440a of the positioning portion 440.

In the cylinder 404, the position of the edge 431b of the joint surface 431 is determined by the groove portion 424. The joint surface 431 is not enlarged to the side of the cylinder bottom 420 regardless of the welding condition, and the deformation amount of the positioning portion 440 when the cylinder 404 receives a tensile load is not increased. Therefore, an increase in the stress in the edge 431b of the joint surface 431 can be prevented, and durability of the cylinder 404 can be improved.

Since the groove portion 414 (see FIG. 15) is not formed on the inner peripheral surface 410b of the cylinder tube 410, a thickness of the cylinder tube 410 can be made constant. Therefore, brittle fracture of the cylinder tube 410 caused by a large load received by the cylinder 401 can be prevented.

Moreover, in the cylinder 404, when the cylinder 404 receives an axial force, the force acting on the cylinder bottom 420 is transmitted to the cylinder tube 410 mainly via a portion located closer to an outer side in the radial direction than the bottom surface of the groove portion 424 in the wall portion 422. The force is not transmitted easily to the edges 431a and 431b of the joint surface 431, and the stress concentration generated in the edges 431a and 431b of the joint surface 431 can be relaxed. Therefore, fatigue destruction of the joint portion 430 by a repetitious load can be prevented.

The cylinder 404 is not limited to a form in which the groove portion 424 is formed on the inner peripheral surface 422b of the wall portion 422. The groove portion 414 may be formed only on the inner peripheral surface 410b of the cylinder tube 410, and the groove portion 424 does not have to be formed on the inner peripheral surface 422b of the wall portion 422. The positioning portion 440 may be formed integrally with the cylinder bottom 420.

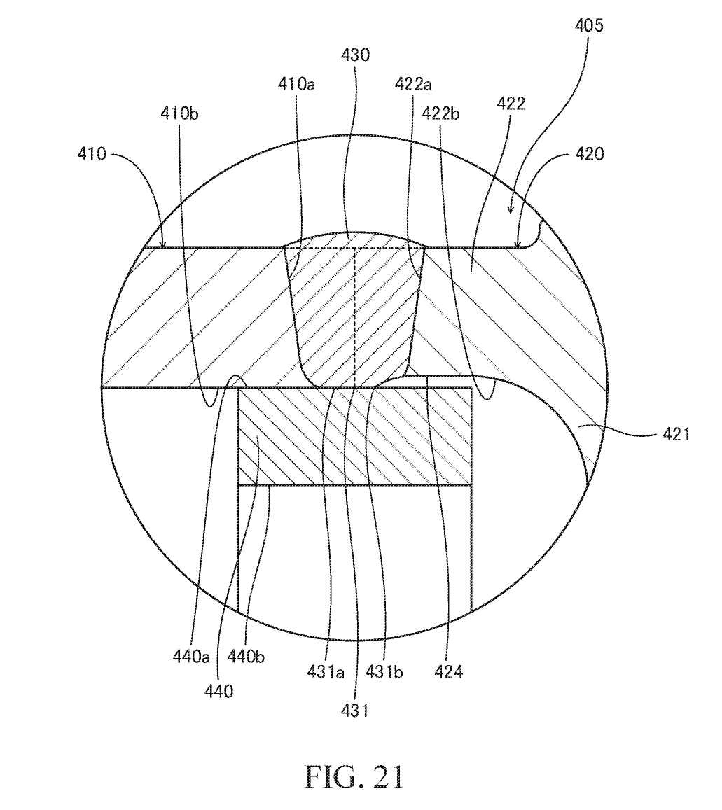

FIG. 21 is an enlarged sectional view illustrating the cylinder 405 according to another variation of this embodiment. In the cylinder 405, the groove portion (first groove portion) 424 is formed on the inner peripheral surface 422b of the wall portion 422. A part of the groove portion 424 is formed on an outer side of a region faced with the positioning portion 440 in the inner peripheral surface 422b of the wall portion 422. That is, even in a state where the cylinder 405 does not receive a tensile load, the groove portion 424 is not sealed by the outer peripheral surface 440a of the positioning portion 440.

In the cylinder 405, too, similarly to the cylinder 404, the position of the edge 431b of the joint surface 431 is determined by the groove portion 424. The joint surface 431 is not enlarged to a side of the cylinder bottom 420 regardless of the welding condition, and the deformation amount of the positioning portion 440 when the cylinder 405 receives a tensile load is not increased. Therefore, an increase in the stress in the edge 431b of the joint surface 431 can be prevented, and durability of the cylinder 405 can be improved.

Moreover, when the cylinder 405 receives an axial force, the force acting on the cylinder bottom 420 is not transmitted easily to the edges 431a and 431b of the joint surface 431, and the stress concentration generated in the edges 431a and 431b of the joint surface 431 can be relaxed. Therefore, fatigue destruction of the joint portion 430 by a repetitious load can be prevented.

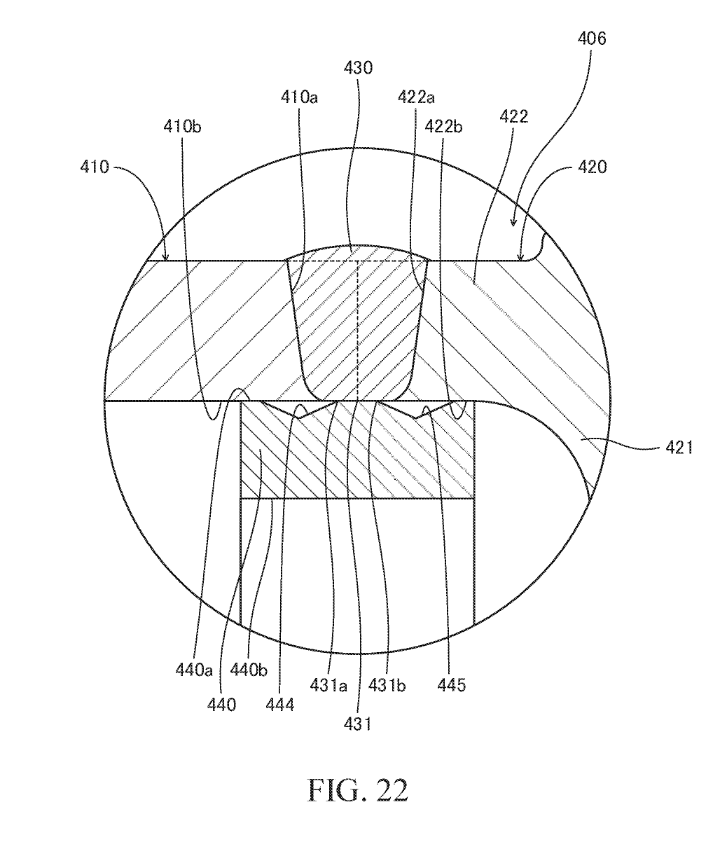

FIG. 22 is an enlarged sectional view illustrating the cylinder 406 according to another variation of this embodiment. In the cylinder 406, the groove portions (second groove portions) 444 and 445 are formed on the outer peripheral surface 440a of the positioning portion 440. Sections of the groove portions 444 and 445 are formed having a triangular shape.

In the cylinder 406, too, similarly to the cylinder 404, the positions of the edges 431a and 431b of the joint surface 431 are determined by the groove portions 444 and 445. The joint surface 431 is not enlarged regardless of the welding condition, and the deformation amount of the positioning portion 440 when the cylinder 406 receives a tensile load is not increased. Therefore, an increase in the stress in the edges 431a and 431b of the joint surface 431 can be prevented, and durability of the cylinder 406 can be improved.

Sectional shapes of the groove portions 414 and 424 (see FIG. 15 and the like) may be triangular. Moreover, the sectional shapes of the groove portions 414, 424, 444, and 445 are not limited to a bow shape or a triangular shape but may be other shapes such as a square, a pentagon and the like.

Constitutions, actions, and effects of the embodiments of the present invention will be described below in summary.

The cylinder 100, 101, 102, 103, 104, 200, 201, 202, 203, 300, 301, 400, 402, 403, 404, 405 includes the cylinder tube 110, 210, 310, 410 and the cylinder bottom 120, 220, 320, 420 having the annular wall portion 122, 222, 322, 422, in which the opening end portion 110a, 210a, 310a, 410a of the cylinder tube 110, 210, 310, 410 and the tip end portion 122a, 222a, 322a, 422a of the wall portion 122, 222, 322, 422 are joined and close the opening of the cylinder tube 110, 210, 310, 410, and on the inner peripheral surface 110b, 210b, 310b, 410b, 122b, 222b, 322b, 422b of at least one of the cylinder tube 110, 210, 310, 410 and the wall portion 122, 222, 322, 422, the annular groove portion 114, 214, 314, 414, 124, 224, 324, 424 extending in the peripheral direction is formed, the inner diameter D3, D43, D4, D44 of the groove portion 114, 214, 314, 414, 124, 224, 324, 424 is larger than the inner diameter D2, D42 of the opening end portion 110a, 210a, 310a, 410a of the cylinder tube 110, 210, 310, 410 and the inner diameter D1, D41 of the tip end portion 122a, 222a, 322a, 422a of the wall portion 122, 222, 322, 422.

In this constitution, the annular groove portion 114, 214, 314, 414, 124, 224, 324, 424 is formed at least on either one of the inner peripheral surface 110b, 210b, 310b, 410b of the cylinder tube 110, 210, 310, 410 and the inner peripheral surface 122b, 222b, 322b, 422b of the wall portion 122, 222, 322, 422, and the inner diameter D3, D43, D4, D44 of the annular groove portion 114, 214, 314, 414, 124, 224, 324, 424 is larger than the inner diameter D2, D42 of the opening end portion 110a, 210a, 310a, 410a of the cylinder tube 110, 210, 310, 410 and the inner diameter D1, D41 of the tip end portion 122a, 222a, 322a, 422a of the wall portion 122, 222, 322, 422. Thus, the axial force acting on the cylinder tube 110, 210, 310, 410 and the cylinder bottom 120, 220, 320, 420 is not transmitted easily to the inner periphery of the opening end portion 110a, 210a, 310a, 410a of the cylinder tube 110, 210, 310, 410 and to the inner periphery of the tip end portion 122a, 222a, 322a, 422a of the wall portion 122, 222, 322, 422. Even if the projection 131 is formed by the joint portion 130, 230, 330, 430 in the vicinity of the inner periphery of the opening end portion 110a, 210a, 310a, 410a of the cylinder tube 110, 210, 310, 410 and in the vicinity of the inner periphery of the tip end portion 122a, 222a, 322a, 422a of the wall portion 122, 222, 322, 422, the stress concentration generated in the root 110c, 210c, 310c, 122c, 222c of the projection 131 can be relaxed, and breakage of the cylinder 100, 101, 102, 103, 104, 200, 201, 202, 203, 300, 301, 400, 402, 403, 404, 405 can be prevented. Therefore, durability of the cylinder 100, 101, 102, 103, 104, 200, 201, 202, 203, 300, 301, 400, 402, 403, 404, 405 can be improved.

Moreover, in the cylinder 100, 102, 103, 104, 200, 202, 203, 300, 301, 400, 402, 404, 405, the groove portion 124, 224, 324, 424 is formed on the inner peripheral surface 122b, 222b, 322b, 422b of the wall portion 122, 222, 322, 422.

In this constitution, since the groove portion 124, 224, 324, 424 is formed on the inner peripheral surface 122b, 222b, 322b, 422b of the wall portion 122, 222, 322, 422, the axial force acting on the cylinder bottom 120, 220, 320, 420 by the pressure of the working oil in the cylinder 100, 102, 103, 104, 200, 202, 203, 300, 301, 400, 402, 404, 405 is not transmitted easily to the inner periphery of the tip end portion 122a, 222a, 322a, 422a of the wall portion 122, 222, 322, 422. Even if the projection 131 is formed by the joint portion 130, 230, 330, 430 in the vicinity of the inner periphery of the tip end portion 122a, 222a, 322a, 422a of the wall portion 122, 222, 322, 422, the stress concentration generated in the root 122c, 222c of the projection 131 can be relaxed more reliably, and breakage of the cylinder 100, 102, 103, 104, 200, 202, 203, 300, 301, 400, 402, 404, 405 can be prevented. Therefore, durability of the cylinder 100, 102, 103, 104, 200, 202, 203, 300, 301, 400, 402, 404, 405 can be improved. Moreover, rigidity of the cylinder bottom 120, 220, 320, 420 is lowered by the groove portion 124, 224, 324, 424 formed on the inner peripheral surface 122b, 222b, 322b, 422b of the wall portion 122, 222, 322, 422, and the cylinder bottom 120, 220, 320, 420 is elastically deformed more easily. The stress concentration generated in the root 110c, 122c, 210c, 222c, 310c of the projection 131 can be relaxed more reliably. Moreover, in the cylinder 100, 200, 300, 402, 404, 405, there is no need to form a groove on the cylinder tube 110, 210, 310, 410 and thus, the cylinder tube 110, 210, 310, 410 can be molded easily.

Moreover, in the cylinder 102, 103, 104, 202, 203, 301, 400, the groove portion 114, 214, 314, 414, 124, 224, 324, 424 is formed on both the inner peripheral surface 110b, 210b, 310b, 410b of the cylinder tube 110, 210, 310, 410 and the inner peripheral surface 122b, 222b, 322b, 422b of the wall portion 122, 222, 322, 422.

In this constitution, since the groove portion 114, 214, 314, 414, 124, 224, 324, 424 is formed on both the inner peripheral surface 110b, 210b, 310b, 410b of the cylinder tube 110, 210, 310, 410 and the inner peripheral surface 122b, 222b, 322b, 422b of the wall portion 122, 222, 322, 422, the axial force acting on the cylinder tube 110, 210, 310, 410 and the cylinder bottom 120, 220, 320, 420 is transmitted less easily to the inner periphery of the opening end portion 110a, 210a, 310a, 410a of the cylinder tube 110, 210, 310, 410 and to the inner periphery of the tip end portion 122a, 222a, 322a, 422a of the wall portion 122, 222, 322, 422. Even if the projection 131 is formed in the vicinity of the inner periphery of the opening end portion 110a, 210a, 310a, 410a of the cylinder tube 110, 210, 310, 410 and in the vicinity of the inner periphery of the tip end portion 122a, 222a, 322a, 422a of the wall portion 122, 222, 322, 422, the stress concentration generated in the root 110c, 210c, 310c, 122c, 222c of the projection 131 can be relaxed more reliably, and breakage of the cylinder 102, 103,104, 202, 203, 301, 400 can be prevented. Therefore, durability of the cylinder 102, 103, 104, 202, 203, 301, 400 can be improved.

Moreover, in the cylinder 200, 201, 202, 203, 400, 402, 403, 404, 405, the positioning portion 240, 440 arranged along the inner peripheral surface 210b, 410b of the cylinder tube 210, 410 and the inner peripheral surface 222b, 422b of the wall portion 222, 422 and determining relative positions of the cylinder tube 210, 410 and the wall portion 222, 422 is further provided.

In this constitution, since the relative positions of the cylinder tube 210, 410 and the wall portion 222, 422 are determined by the positioning portion 240, 440, the cylinder tube 210, 410 and the wall portion 222, 422 are not deviated easily in the radial direction at joining. Therefore, formation of an unintended stepped part between the cylinder tube 210, 410 and the wall portion 222, 422 can be prevented, and durability of the cylinder 200, 201, 202, 203, 400, 402, 403, 404, 405 can be improved.

Moreover, in the cylinder 300, 301, the wall portion 322 has the positioning portion 340 arranged along the inner peripheral surface 310b of the cylinder tube 310 and determining relative positions of the cylinder tube 310 and the wall portion 322.

In this constitution, since the relative positions of the cylinder tube 310 and the wall portion 322 are determined by the positioning portion 340, the cylinder tube 310 and the wall portion 322 are not deviated easily in the radial direction at joining. The formation of an unintended stepped part between the cylinder tube 310 and the wall portion 322 can be prevented. Moreover, the positioning portion 340 is formed on the wall portion 322. There is no need to align the positions of the wall portion 322 and the positioning portion 340 at joining, and the cylinder tube 310 and the wall portion 322 can be joined easily. Therefore, the cylinder 300, 301 whose durability can be improved can be manufactured easily.

Moreover, in the cylinder 200, 201, 300, 301, the groove portion 214, 314, 224, 324 is formed on the outer side of the region faced with the positioning portion 240, 340 in the inner peripheral surface 210b, 310b of the cylinder tube 210, 310 and the inner peripheral surface 222b, 322b of the wall portion 222, 322.

In this constitution, since the groove portion 214, 314, 224, 324 is formed on the outer side of the region faced with the positioning portion 240, 340 in the inner peripheral surface 210b, 310b of the cylinder tube 210, 310 and the inner peripheral surface 222b, 322b of the wall portion 222, 322, the positioning portion 240, 340 is in contact with the inner peripheral surface 210b, 310b of the cylinder tube 210, 310 and the inner peripheral surface 222b, 322b of the wall portion 222, 322 in a wider range, and the cylinder tube 210, 310 and the wall portion 222, 322 are deviated less easily in the radial direction at joining. Therefore, formation of an unintended stepped part between the cylinder tube 210, 310 and the wall portion 222, 322 can be prevented more reliably, and durability of the cylinder 200, 201, 300, 301 can be improved.

Moreover, this embodiment relates to the hydraulic cylinder 1A, 1B extended/contracted by supply/discharge of the working oil to/from the cylinder. The cylinder is the cylinder 100, 101, 102, 103, 104, 200, 201, 202, 203, 300, 301, 400, 402, 403, 404, 405.

In this constitution, since the cylinder is the aforementioned cylinder 100, 101, 102, 103, 104, 200, 201, 202, 203, 300, 301, 400, 402, 403, 404, 405, the cylinder has high durability. Therefore, durability of the hydraulic cylinder 1A, 1B can be improved.

Moreover, in the cylinder 400, 402, 403, 404, 405, a part of the outer peripheral surface 440a of the positioning portion 440 is joined to the joint portion 430 between the opening end portion 410a of the cylinder tube 410 and the tip end portion 422a of the wall portion 422, and the joint portion 430 is faced with the groove portion 414, 424.

In this constitution, since the joint portion 430 is faced with the groove portion 414, 424 extending in the peripheral direction, the positions of the edges 431a and 431b of the joint surface 431 between the joint portion 430 and the positioning portion 440 is determined. Enlargement of the joint width L can be prevented regardless of the condition at welding, and the increase in the stress in the joint portion 430 can be prevented. Therefore, durability of the cylinder 400, 402, 403, 404, 405 can be improved.

Moreover, in the cylinder 402, 403, the groove portion 444, 445 extending in the peripheral direction is formed on the outer peripheral surface 440a of the positioning portion 440, and the joint portion 430 is faced with the groove portion 444, 445.

In this constitution, since the joint portion 430 is faced with the groove portion 444, 445, the positions of the edges 431a and 431b of the joint surface 431 between the joint portion 430 and the positioning portion 440 is determined by the groove portion 333, 334. Enlargement of the joint width L can be prevented regardless of the condition at welding, and the increase in the stress in the joint portion 430 can be prevented. Therefore, durability of the cylinder 402, 403 can be improved.

Moreover, in the cylinder 400, the groove portion 414, 424 is formed on both the inner peripheral surface 410b of the cylinder tube 410 and the inner peripheral surface 422b of the wall portion 422.

In this constitution, since the groove portion 414 is formed on the inner peripheral surface 410b of the cylinder tube 410 and the groove portion 424 is formed on the inner peripheral surface 422b of the wall portion 422, the axial force acting on the cylinder tube 410 and the cylinder bottom 420 is not transmitted easily to the both edges 431a and 431b of the joint surface 431. The stress concentration generated in the both edges 431a and 431b of the joint surface 431 can be relaxed, and fatigue destruction of the joint portion 430 by the repetitious load can be prevented. Therefore, durability of the cylinder 400 can be improved.

In the cylinder 400, 402, 403, 404, the groove portion 414, 424 is sealed by the outer peripheral surface 440a of the positioning portion 440.

In this constitution, since the groove portion 414, 424 is sealed by the outer peripheral surface 440a of the positioning portion 440, the both ends of the positioning portion 440 in the axial direction is in contact with the cylinder tube 410 and the wall portion 422 at welding. Deviation of the cylinder tube 410 and the cylinder bottom 420 in the radial direction can be prevented more reliably, and formation of an unintended stepped part between the cylinder tube 410 and the wall portion 422 can be prevented. Therefore, durability of the cylinder 402, 403, 404 can be improved.

Moreover, in the cylinder 402, the groove portion 424 is formed on the inner peripheral surface 422b of the wall portion 422, and the groove portion 444 is formed in the region faced with the inner peripheral surface 410b of the cylinder tube 410 in the outer peripheral surface 440a of the positioning portion 440.

In this constitution, since the groove portion 424 is formed on the inner peripheral surface 422b of the wall portion 422, the axial force acting on the cylinder bottom 420 is not transmitted easily to the edge 431b of the joint surface 431 between the joint portion 430 and the positioning portion 440. Therefore, the stress concentration generated in the edge 431b of the joint surface 431 can be relaxed, and fatigue destruction of the joint portion 430 by a repetitious load can be prevented. Moreover, since the groove portion 444 is formed on the outer peripheral surface 440a of the positioning portion 440, the groove portion 414 does not have to be formed on the inner peripheral surface 410b of the cylinder tube 410, and the thickness of the cylinder tube 410 can be made constant. Therefore, the brittle fracture of the cylinder tube 410 caused by a large load received by the cylinder 402 can be prevented.

Moreover, in the cylinder 403, the groove portion 414 is formed on the inner peripheral surface 410b of the cylinder tube 410, and the groove portion 445 is formed in the region faced with the inner peripheral surface 422b of the wall portion 422 in the outer peripheral surface 440a of the positioning portion 440.

In this constitution, since the groove portion 414 is formed on the inner peripheral surface 410b of the cylinder tube 410, the axial force acting on the cylinder tube 410 is not transmitted easily to the edge 431a of the joint surface 431 between the joint portion 430 and the positioning portion 440. Therefore, the stress concentration generated in the edge 431a of the joint surface 431 can be relaxed, and fatigue destruction of the joint portion 430 by a repetitious load can be prevented. Moreover, since the groove portion 445 is formed on the outer peripheral surface 440a of the positioning portion 440, the groove portion 424 does not have to be formed on the inner peripheral surface 422b of the wall portion 422, and the thickness of the wall portion 422 can be made constant. Therefore, the brittle fracture of the wall portion 422 caused by a large load received by the cylinder 403 can be prevented.

Moreover, this embodiment relates to the hydraulic cylinder 1B expanded/contracted by supply/discharge of the working oil to/from the cylinder. The cylinder is the cylinder 400, 402, 403, 404, 405.

In this constitution, since the cylinder is the aforementioned cylinder 400, 402, 403, 404, 405, the cylinder has high durability. Therefore, durability of the hydraulic cylinder 1B can be improved.

In this embodiment, the cylinder 400, 401, 402, 403, 404, 405, 406 has the cylindrical cylinder tube 410, the cylinder bottom 420 having the annular wall portion 422 and having the opening end portion 410a of the cylinder tube 410 and the tip end portion 422a of the wall portion 422 joined through the joint portion 430 and closing the opening of the cylinder tube 410, and the annular positioning portion 440 arranged along the inner peripheral surface 410b of the cylinder tube 410 and the inner peripheral surface 422b of the wall portion 422 and determining relative positions of the cylinder tube 410 and the cylinder bottom 420, and a part of the outer peripheral surface 440a of the positioning portion 440 is joined to the joint portion 430, and the groove portion 414, 424, 444, 445 extending in the peripheral direction is formed on at least one of the inner peripheral surface 410b of the cylinder tube 410, the inner peripheral surface 422b of the wall portion 422, and the outer peripheral surface 440a of the positioning portion 440, and the joint portion 430 is faced with the groove portion 414, 424, 444, 445.

In this constitution, since the joint portion 430 is faced with the groove portion 414, 424, 444, 445 extending in the peripheral direction, the positions of the edges 431a and 431b of the joint surface 431 between the joint portion 430 and the positioning portion 440 are determined by the groove portion 414, 424, 444, 445. Enlargement of the joint width L can be prevented regardless of the condition at welding, and the increase in the stress in the joint portion 430 can be prevented. Therefore, durability of the cylinder 400, 401, 402, 403, 404, 405, 406 can be improved.

Moreover, in this embodiment, the groove portion 414, 424, 444, 445 is provided on both sides of the joint portion 430 in the axial direction.

In this constitution, since the groove portion 414, 424, 444, 445 is provided on both sides of the joint portion 430, the positions of the both edges 431a and 431b of the joint surface 431 between the joint portion 430 and the positioning portion 440 are determined by the two groove portions 414, 424, 444, 445. Enlargement of the joint width L can be prevented regardless of the condition at welding, and the increase in the stress in the joint portion 430 can be prevented more reliably. Therefore, durability of the cylinder 400, 401, 402, 403, 406 can be improved.

Moreover, in this embodiment, the groove portion 444, 445 is formed on the outer peripheral surface 440a of the positioning portion 440.

In this constitution, since the groove portion 444, 445 is formed on the outer peripheral surface 440a of the positioning portion 440, the groove portion 414, 424 does not have to be formed on the cylinder tube 410 and the wall portion 422, and the thicknesses of the cylinder tube 410 and the wall portion 422 can be made constant. Therefore, brittle fracture of the cylinder tube 410 and the wall portion 422 caused by a large load received by the cylinder 401, 406 can be prevented.

The embodiments of the present invention described above are merely illustration of some application examples of the present invention and not of the nature to limit the technical scope of the present invention to the specific constructions of the above embodiments.

In the aforementioned embodiment, the cylinder used for the hydraulic cylinder 1A, 1B was described as a pressure resistant apparatus. The pressure resistant apparatus is not limited to them but may be a pressure vessel such as a bomb for storing a liquid or a gas.

The constitution illustrated in each variation and the constitution described in each embodiment can be combined, the constitutions described in the aforementioned different embodiments can be combined, or the constitutions described in different variations can be also combined.

The present application claims a priority based on Japanese Patent Application No. 2016-083129 filed with the Japan Patent Office on Apr. 18, 2016, and Japanese Patent Application No. 2016-083130 filed with the Japan Patent Office on Apr. 18, 2016, all the contents of which are hereby incorporated by reference.

1. A pressure resistant apparatus, comprising:
a cylindrical body portion; and
a lid portion having an annular wall portion, end portions of the body portion and the wall portion being joined to each other to close an opening of the body portion by the lid portion, wherein
an annular first groove portion is formed to extend in a peripheral direction on at least one of inner peripheral surfaces of the body portion and the wall portion; and
an inner diameter of the first groove portion is larger than inner diameters of the body portion and the end portion of the wall portion.

2. The pressure resistant apparatus according to claim 1, wherein
the first groove portion is formed on an inner peripheral surface of the wall portion.

3. The pressure resistant apparatus according to claim 1, wherein
the first groove portion is formed on both the inner peripheral surface of the body portion and the inner peripheral surface of the wall portion.

4. The pressure resistant apparatus according to claim 1, further comprising:
a positioning portion arranged along the inner peripheral surfaces of the body portion and the wall portion, the positioning portion being configured to determine relative positions of the body portion and the wall portion.

5. The pressure resistant apparatus according to claim 1, wherein
one of the body portion and the wall portion has a positioning portion arranged along the other inner peripheral surface, the positioning portion being configured to determine relative positions of the body portion and the wall portion.

6. The pressure resistant apparatus according to claim 4, wherein
the first groove portion is formed on an outer side of a region faced with the positioning portion in the inner peripheral surfaces of the body portion and the wall portion.

7. A fluid pressure cylinder configured to extend and contract by supply or discharge of a working fluid to or from a cylinder, wherein
the cylinder is the pressure resistant apparatus according to claim 1.

8. The pressure resistant apparatus according to claim 4, wherein
a part of an outer peripheral surface of the positioning portion is joined to a joint portion between the end portions of the body portion and the wall portion; and
the joint portion is faced with the first groove portion.

9. The pressure resistant apparatus according to claim 8, wherein
a second groove portion is formed to extend in the peripheral direction on the outer peripheral surface of the positioning portion; and
the joint portion is faced with the second groove portion.

10. The pressure resistant apparatus according to claim 8, wherein
the first groove portion is formed on both the inner peripheral surface of the body portion and the inner peripheral surface of the wall portion.

11. The pressure resistant apparatus according to claim 8, wherein
the first groove portion is sealed by the outer peripheral surface of the positioning portion.

12. The pressure resistant apparatus according to claim 9, wherein
the first groove portion is formed on the inner peripheral surface of the wall portion; and
the second groove portion is formed in a region faced with the inner peripheral surface of the body portion in the outer peripheral surface of the positioning portion.

13. The pressure resistant apparatus according to claim 9, wherein
the first groove portion is formed on the inner peripheral surface of the body portion; and
the second groove portion is formed in a region faced with the inner peripheral surface of the wall portion in the outer peripheral surface of the positioning portion.

14. A fluid pressure cylinder configured to extend and contract by supply or discharge of a working fluid to or from a cylinder, wherein
the cylinder is the pressure resistant apparatus according to claim 8.
